(19) United States
(12) Patent Application Publication
(10) Pub. No.: US 2022/0396722 A1
(43) Pub. Date: Dec. 15, 2022

(54) SHAPED ABRASIVE PARTICLES WITH CONCAVE VOID WITHIN ONE OF THE PLURALITY OF EDGES

(71) Applicant: 3M INNOVATIVE PROPERTIES COMPANY, St. Paul, MN (US)

(72) Inventors: Joseph B. Eckel, Vadnais Heights, MN (US); Fay T. Salmon, Eden Prairie, MN (US); Aaron K. Nienaber, Lake Elmo, MN (US); Thomas J. Nelson, Woobury, MN (US); Cory M. Arthur, Eagan, MN (US); Alireza Ghaderi, Woodbury, MN (US); Ronald D. Jesme, Plymouth, MN (US); David T. Buckley, Falcon Heights, MN (US)

(21) Appl. No.: 17/755,014

(22) PCT Filed: Oct. 23, 2020
(86) PCT No.: PCT/IB2020/059971

§ 371 Date: Apr. 19, 2022

Related U.S. Application Data
(60) Provisional application No. 62/924,956, filed on Oct. 23, 2019.

(51) Int. Cl. C09K 3/14; B24D 11/00

(52) U.S. Cl. CPC C09K 3/1409; B24D 11/001

(57) ABSTRACT

A shaped abrasive particle is presented. The shaped abrasive particle has a first and second surface. The first and second surfaces are substantially parallel to each other and separated by a thickness. Each of the first and second surfaces have a surface profile, which includes a plurality of corners and a plurality of edges connecting the plurality of corners. The shaped abrasive particle also includes a recess included wholly within one of the plurality of edges, wherein the recess is a concave void extending into the surface profile. The shaped abrasive particle also includes a magnetically responsive coating. The magnetically responsive coating causes the shaped abrasive particle to be responsive to a magnetic field. The shaped abrasive particle, when exposed to the magnetic field, experiences a net torque that causes the shaped abrasive particle to orient with respect to the magnetic field such that each of the first and second surfaces are substantially perpendicular to a backing.

### BACKGROUND

Abrasive particles and abrasive articles including abrasive particles are useful for abrading, finishing, or grinding a wide variety of materials and surfaces in the manufacturing of goods. As such, there continues to be a need for improving the cost, performance, or life of abrasive particles or abrasive articles.

### SUMMARY OF THE DISCLOSURE

A shaped abrasive particle is presented. The shaped abrasive particle has a first and second surface. The first and second surfaces are substantially parallel to each other and separated by a thickness. Each of the first and second surfaces have a surface profile, which includes a plurality of corners and a plurality of edges connecting the plurality of corners. The shaped abrasive particle also includes a recess included wholly within one of the plurality of edges, wherein the recess is a concave void extending into the surface profile. The shaped abrasive particle also includes a magnetically responsive coating. The magnetically responsive coating causes the shaped abrasive particle to be responsive to a magnetic field. The shaped abrasive particle, when exposed to the magnetic field, experiences a net torque that causes the shaped abrasive particle to orient with respect to the magnetic field such that each of the first and second surfaces are substantially perpendicular to a backing.

### BRIEF DESCRIPTION OF THE FIGURES

The drawings illustrate generally, by way of example, but not by way of limitation, various embodiments discussed in the present document.

FIG. 1 is an abrasive article in which embodiments of the present invention may be useful.

FIGS. 2A and 2B illustrate views of a shaped abrasive particle in accordance with an embodiment of the present invention.

FIG. 3 is a side view of an abrasive belt, in accordance with various embodiments.

FIGS. 4A and 4B are illustrative schematics for aligning shaped abrasive particles on a coated abrasive article in accordance with an embodiment of the present invention.

FIG. 5 is a diagram illustrating the effect of a magnetic field on an abrasive particle.

FIGS. 6A-6C illustrate views of shaped abrasive particles in accordance with an embodiment of the present invention.

FIGS. 7A and 7B illustrate torque diagrams of abrasive particles experiencing a magnetic field.

FIGS. 8A-8L illustrate shaped abrasive particles in accordance with an embodiment of the present invention.

FIG. 9 illustrates a method of making a coated abrasive article in accordance with an embodiment of the present invention.

FIGS. 10-32 illustrate particles described in the Examples.

### DETAILED DESCRIPTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “shaped abrasive particle,” means an abrasive particle with at least a portion of the abrasive particle having a predetermined shape that is replicated from a mold cavity used to form the shaped precursor abrasive particle. Except in the case of abrasive shards (e.g. as described in US Patent Application Publication Nos. 2009/0169816 and 2009/0165394), the shaped abrasive particle will generally have a predetermined geometric shape that substantially replicates the mold cavity that was used to form the shaped abrasive particle. Shaped abrasive particle as used herein excludes abrasive particles obtained by a mechanical crushing operation. Suitable examples for geometric shapes having at least one vertex include polygons (including equilateral, equiangular, star-shaped, regular and irregular polygons), lens-shapes, lune-shapes, circular shapes, semicircular shapes, oval shapes, circular sectors, circular segments, drop-shapes and hypocycloids (for example super elliptical shapes).

The term “ferrimagnetic” refers to materials that exhibit ferrimagnetism. Ferrimagnetism is a type of permanent magnetism that occurs in solids in which the magnetic fields associated with individual atoms spontaneously align themselves, some parallel, or in the same direction (as in ferromagnetism), and others generally antiparallel, or paired off in opposite directions (as in antiferromagnetism). The magnetic behavior of single crystals of ferrimagnetic materials may be attributed to the parallel alignment; the diluting effect of those atoms in the antiparallel arrangement keeps the magnetic strength of these materials generally less than that of purely ferromagnetic solids such as metallic iron. Ferrimagnetism occurs chiefly in magnetic oxides known as ferrites. The spontaneous alignment that produces ferrimagnetism is entirely disrupted above a temperature called the Curie point, characteristic of each ferrimagnetic material. When the temperature of the material is brought below the Curie point, ferrimagnetism revives.

The term “ferromagnetic” refers to materials that exhibit ferromagnetism. Ferromagnetism is a physical phenomenon in which certain electrically uncharged materials strongly attract others. In contrast to other substances, ferromagnetic materials are magnetized easily, and in strong magnetic fields the magnetization approaches a definite limit called saturation. When a field is applied and then removed, the magnetization does not return to its original value. This phenomenon is referred to as hysteresis. When heated to a certain temperature called the Curie point, which is generally different for each substance, ferromagnetic materials lose their characteristic properties and cease to be magnetic; however, they become ferromagnetic again on cooling.

The terms “magnetic” and “magnetized” mean being ferromagnetic or ferrimagnetic at 20° C., or capable of being made so, unless otherwise specified. Preferably, magnetizable layers according to the present disclosure either have, or can be made to have by exposure to an applied magnetic field.

The term “magnetic field” refers to magnetic fields that are not generated by any astronomical body or bodies (e.g., Earth or the sun). In general, magnetic fields used in practice of the present disclosure have a field strength in the region of the magnetizable abrasive particles being oriented of at least about 10 gauss (1 mT), preferably at least about 100 gauss (10 mT), and more preferably at least about 1000 gauss (0.1 T).

The term “magnetizable” means capable of being magnetized or already in a magnetized state.

For the purposes of this invention, geometric shapes are also intended to include regular or irregular polygons or stars wherein one or more edges (parts of the perimeter of the face) can be arcuate (either of towards the inside or towards the outside, with the first alternative being preferred). Hence, for the purposes of this invention, triangular shapes also include three-sided polygons wherein one or more of the edges (parts of the perimeter of the face) can be arcuate. The second side may comprise (and preferably is) a second face. The second face may have a perimeter of a second geometric shape.

For the purposes of this invention, shaped abrasive particles also include abrasive particles comprising faces with different shapes, for example on different faces of the abrasive particle. Some embodiments include shaped abrasive particles with different shaped opposing sides. The different shapes may include, for example, differences in surface area of two opposing sides, or different polygonal shapes of two opposing sides.

The shaped abrasive particles are typically selected to have an edge length in a range of from 0.001 mm to 26 mm, more typically 0.1 mm to 10 mm, and more typically 0.5 mm to 5 mm, although other lengths may also be used.

The shaped abrasive particle may have a “sharp portion” which is used herein to describe either a sharp tip or a sharp edge of an abrasive article. The sharp portion may be defined using a radius of curvature, which is understood in this disclosure, for a sharp point, to be the radius of a circular arc which best approximates the curve at that point. For a sharp edge, the radius of curvature is understood to be the radius of the curvature of the profile of the edge on the plane perpendicular to the tangent direction of the edge. Further, the radius of curvature is the radius of a circle which best fits a normal section, or an average of sections measured, along the length of the sharp edge. The smaller a radius of curvature, the sharper the sharp portion of the abrasive particle. Shaped abrasive particles with sharp portions are defined in U.S. Provisional Patent Application Ser. No. 62/877,443, filed on Jul. 23, 2019, which is hereby incorporated by reference.

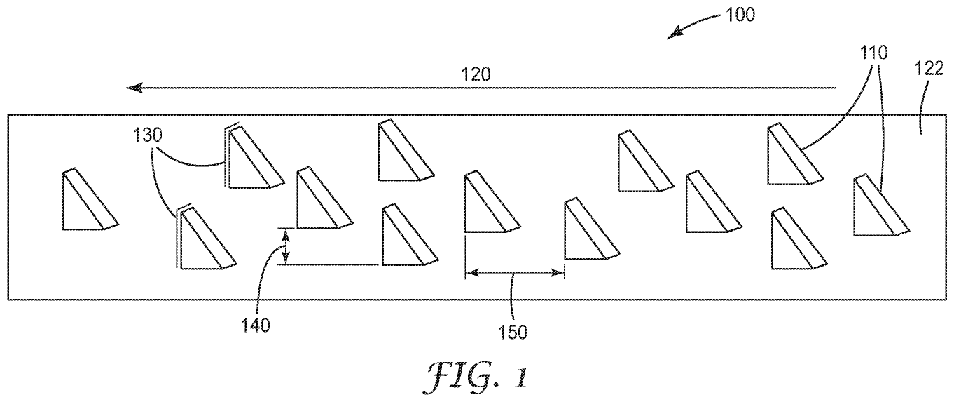

FIG. 1 is an abrasive article in which embodiments of the present invention may be useful. A coated abrasive article 100, in one embodiment, includes a plurality of shaped abrasive particles 110 adhered to a backing 102. A cutting direction of abrasive particle 110 is illustrated by arrow 120. Abrasive particles are arranged on backing 102 such that a cutting face 130 of each abrasive article is exposed to abrade a surface. As illustrated by parallel lines 140, in some embodiments, at least a majority of cutting faces 130 are aligned in parallel with each other. In some embodiments, at least about 50%, or at least about 60%, or at least about 70%, or at least about 80%, or at least about 90%, or at least about 95%, or substantially all of cutting faces 130 are aligned with respect to each other. Additionally, at least a majority of abrasive particle bases of abrasive particles are also aligned with respect to each other, as indicated by reference numeral 150. In one embodiment, abrasive particle bases are aligned perpendicularly to a web direction, as indicated by parallel lines 150. In some embodiments, at least about 50%, or at least about 60%, or at least about 70%, or at least about 80%, or at least about 90%, or at least about 95%, or substantially all of bases are aligned with respect to each other.

Orientation of abrasive particles is particularly important for the efficacy of an abrasive article. For example, a shaped abrasive particle may have a sharp tip or a sharp edge that should be oriented away from a backing material. Sharp edges, as discussed in greater detail below, may have a preferred abrading orientation and may have different abrading properties depending on whether a cutting surface is leading or trailing during an abrading operation. Orientation of the abrasive particles in coated abrasive articles generally has an influence on abrading properties. In the instance that the abrasive particles are precisely-shaped (e.g., into triangular platelets or conical particles), this effect of orientation can be especially important as discussed in U.S. Pat. Appl. Publ. No. 2013/0344786 A1 (Keipert), incorporated by reference herein.

The orientation and alignment of particles 110 is beneficial for several reasons. Particles described herein may have a sharp cutting edge along a cutting face. Orienting such particles so that the cutting face is perpendicular to a web direction allows for sustained and higher cut rates of abrasive articles. Specifically, a 90° orientation with respect to a web direction can help reduce wear flat by enabling subsequent fracturing of a shaped abrasive particle more easily after they have already fractured.

A solution is needed that can align shaped particles substantially perpendicular to the web direction while orienting a sharp edge or tip of the abrasive particle away from the backing, as illustrated in FIG. 1. The solution should also be able to orient precision shaped abrasive particles with a forward to backward tilt to achieve a desired rake angle. Rake angles are described in greater detail in co-owned provisional patent application with Ser. No. 62/754,225 filed on Nov. 1, 2018, incorporated by reference herein.

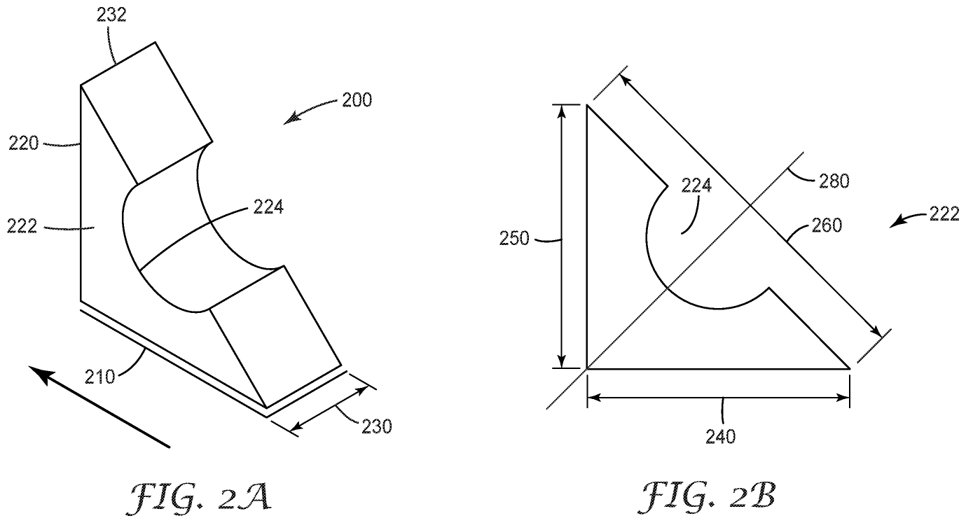

FIGS. 2A and 2B illustrate views of a shaped abrasive particle in accordance with an embodiment of the present invention. The shaped abrasive particles illustrated in FIGS. 2A and 2B can be manipulated by a magnetic field in order to achieve the desired orientation illustrated in FIG. 1. Specifically, the design of particle 200 causes the particle to experience two magnetic moments, potentially with different values, that result in a net magnetic torque that causes the particle to orient itself perpendicularly to a web direction. For an abrasive article with a plurality of such shaped particles, the particles will also orient themselves parallel to each other, such that the cutting faces of each particle are oriented in the same direction.

FIG. 2A illustrates a perspective view of a shaped abrasive particle 200. FIG. 2B illustrates a side view of abrasive particle 200, showing more clearly the design of surface 222. Abrasive particle 200 has two surfaces 222, separated by a thickness 230. Thickness 230 defines a cutting edge 232 of a cutting face 220. However, while only one cutting edge 232 is called out in FIG. 2A, abrasive particle 200 is symmetrical about a line of symmetry 280, such that cutting face 220 and base 210 may be interchangeable. This can allow for a greater number of abrasive particles aligning correctly. However, while a symmetrical design is present in some embodiments illustrated herein, it is expressly contemplated that other designs may also be possible in other embodiments.

Abrasive particle 200 has a surface 222 shaped like a triangle with a height 250, a length 240, and a theoretical hypotenuse 260. However, as illustrated in FIGS. 2A and 2B, an actual third side of abrasive particle 200 is interrupted by a concave defect 224. Concave defect 224, in one embodiment, is curved. However, in another embodiment concave defect includes at least one straight portion, or only straight portions. The particular design of concave defect 224 may be dictated, at least in part, by manufacturing considerations of abrasive particles.

With respect to FIG. 2B, abrasive particle 200, in one embodiment, has two substantially identical surfaces 222 separated by thickness 230. Abrasive particle 200 can be described with respect to a theoretical triangle that could be defined by height 250, length 240, and hypotenuse 260, were defect 224 not present. For example, in one embodiment, abrasive particle 200 is at least 80% of a theoretical abrasive particle.

Adding a concave defect 224 to a polygon causes abrasive particle 200, when magnetically coated to behave differently when exposed to a magnetic field than a similar polygonal shaped abrasive particle without defect 224. For example, as discussed below, abrasive particle 200 can be coated with a magnetically responsive coating. Exposing a magnetically coated abrasive particle 200 to a magnetic field will case a net magnetic torque to act on abrasive particle 200, causing an abrasive particle 200 that landed flat on surface 222 to stand up and rest on thickness 230 instead.

While FIGS. 2A and 2B illustrate a theoretical right triangle shape for surface 222, it is expressly contemplated that other polygonal shapes can serve as the basis for an abrasive particle 200. For example, another triangle shape, such as a scalene, isosceles, equilateral, acute or obtuse triangle may also serve as a theoretical polygonal shape for an abrasive particle, with a defect designed to similarly effect a net magnetic torque on the particle. Additionally, a parallelogram, rectangle, square or other four-sided shape may also serve as a theoretical polygonal basis for an abrasive particle.

The shape of each face 222, can be controlled, in part, by varying the length of either height 250 or length 240. While each edge can have any suitable length, each edge can generally have a length in a range of from about 0.01 mm to about 10 mm, about 0.03 mm to about 5 mm, less than, equal to, or greater than about 0.01 mm, 0.05, 0.1, 0.5, 1, 1.5, 2, 2.5, 3, 3.5, 4, 4.5, 5, 5.5, 6, 6.5, 7, 7.5, 8, 8.5, 9, 9.5, or about 10 mm.

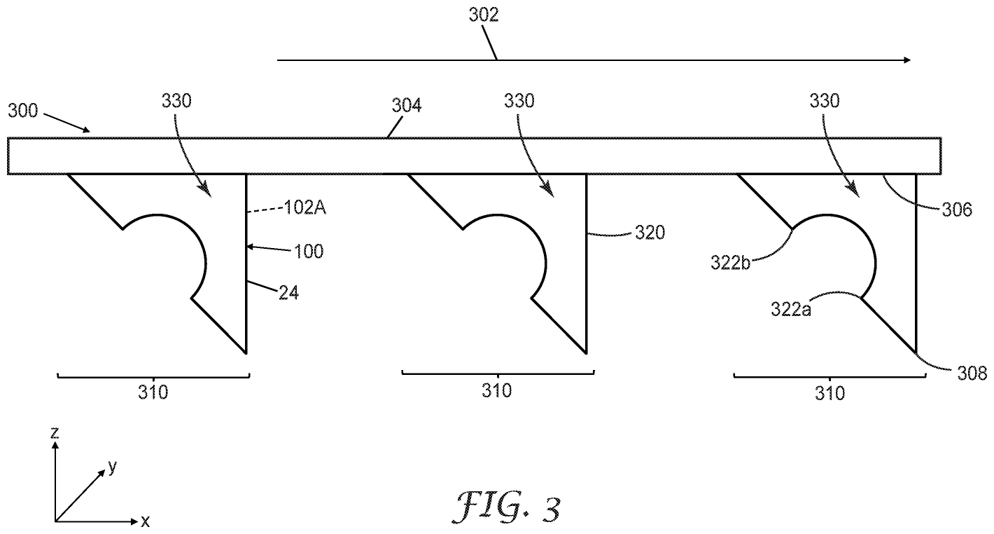

FIG. 3 is a side view of an abrasive belt, in accordance with various embodiments. Abrasive belt 300 includes backing 304 having shaped abrasive particles 310 attached thereto. Direction of use 302 for abrasive belt 300 extends in one direction along an x-axis orthogonal to both the z-axis and the y-axis. As shown, a base face 306 of least one shaped abrasive particle 300 is substantially in contact with backing 304. A cutting face 320 is aligned with direction of use 302, such that a sharp portion 308, e.g. either a sharp tip 308 or a sharp edge 308, is aligned to contact a workpiece for abrasion. A defect face 330 has substantially no direct contact with backing 304. Defect face 330 includes a concave defect 332. Defect 332 comprises a concave cut-out of defect face 330. In one embodiment, defect 332 can be defined as having a first defect edge 332a and a second defect edge 332b, where neither 332a nor 332b connects to cutting face 320 or base 306.

In the embodiment illustrated in FIG. 3, each of base face 306, cutting face 320, and defect face 330, with the exception of defect 332, are straight and substantially without curvature. However, it is expressly contemplated that, in other embodiments, any or all faces have curvature. Defect 332, however, is separate from any curvature of defect face 330.

Backing 304 can have any desirable degree of flexibility. Backing 304 can include any suitable material. For example, backing 304 can include a polymeric film, a metal foil, a woven fabric, a knitted fabric, paper, a vulcanized fiber, a nonwoven, a foam, a screen, a laminate, or combinations thereof. Backing 304 can further include various additive(s). Examples of suitable additives include colorants, processing aids, reinforcing fibers, heat stabilizers, UV stabilizers, and antioxidants. Examples of useful fillers include clays, calcium carbonate, glass beads, talc, clays, mica, wood flour; and carbon black.

Shaped abrasive particle 310 can be positioned relative to backing 304 to achieve several performance characteristics of abrasive belt 300. The positioning of shaped abrasive particle 310 can be characterized by a variety of different angles of shaped abrasive particle 310, relative to backing 304.

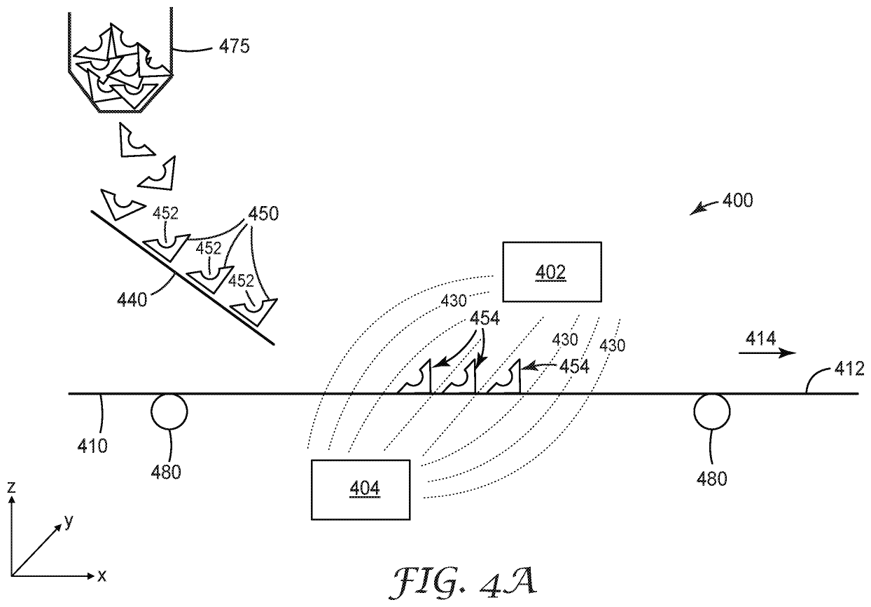

FIGS. 4A and 4B are schematic illustrations for aligning shaped abrasive particles on a coated abrasive article in accordance with an embodiment of the present invention. FIG. 4A illustrates a system 400 for aligning magnetically responsive abrasive particles on a backing using a magnetic field. Precise orientation of shaped abrasive particles 450 can be achieved using shaped abrasive particles that include at least some magnetic material and exposing them to a magnetic field. Shaped abrasive particles can include magnetic material in their composition, can be coated with a layer of magnetic material or both.

The magnetically responsive shaped abrasive particles can be arranged randomly on backing 410. Shaped abrasive particles 450 can then be exposed to a magnetic field 430 in such a manner that shaped abrasive particles 450 are oriented. Once properly oriented, shaped abrasive particles 450 can be adhered to backing 410 with a resin binder, referred to as a make coat. Optionally, additional layers, such as a size coat, can also be applied. As a result of this process, individual shaped abrasive particles 450 are positioned on backing 410 such that abrasive particles 450 are parallel to each other and have cutting faces facing in a downweb direction 414.

FIG. 4A illustrates a backing 410 receiving abrasive particles 450 from a hopper 475. Backing 410 may have a make layer or make layer precursor (not shown) disposed thereon. Backing 410 moves along web path 412 in a downweb direction 414 (e.g., machine direction). Backing 410 has a crossweb direction (not shown) that is perpendicular to downweb direction 414. Magnetizable particles 450 (having a structure corresponding to shaped abrasive particles 200) are dropped through a portion of applied magnetic field 430 onto backing 410. At least some of magnetizable particles 450 are abrasive particles with a defect 452 that causes them to experience a net magnetic torque when exposed to magnetic field 430.

Magnetizable particles 450 are predominantly deposited onto backing 410 after travelling down downward sloping dispensing surface 440, which is fed from hopper 475. Various web handling components 480 (e.g., rollers, conveyor belts, feed rolls, and take up rolls) handle backing 410.

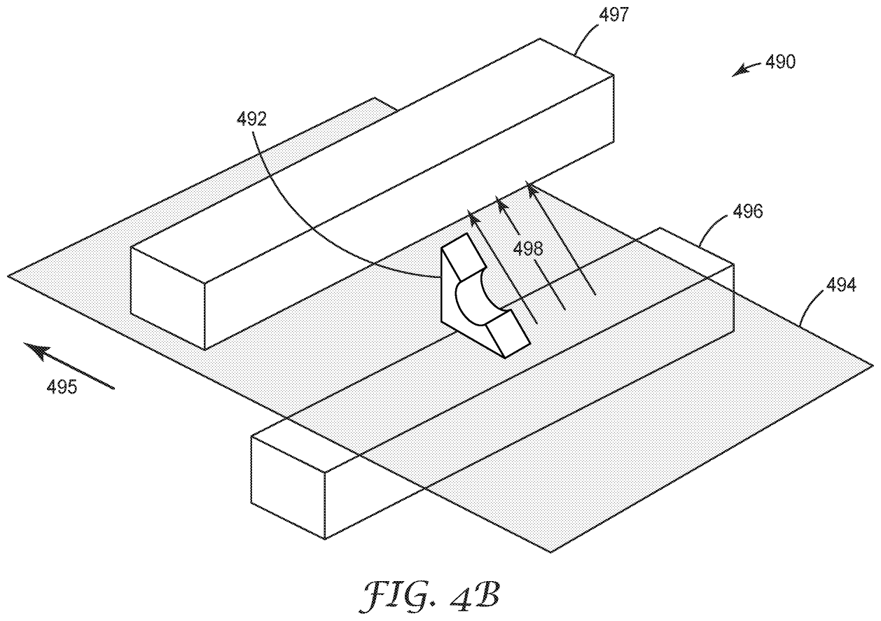

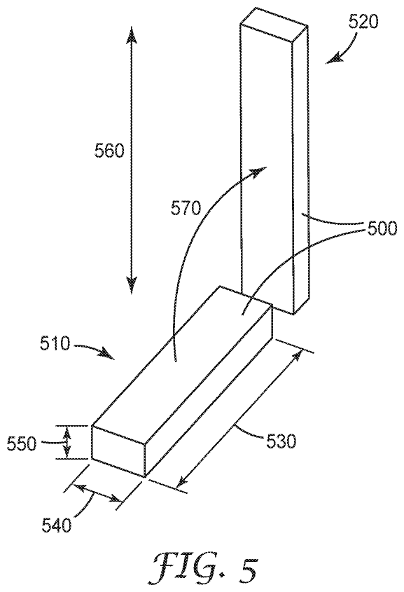

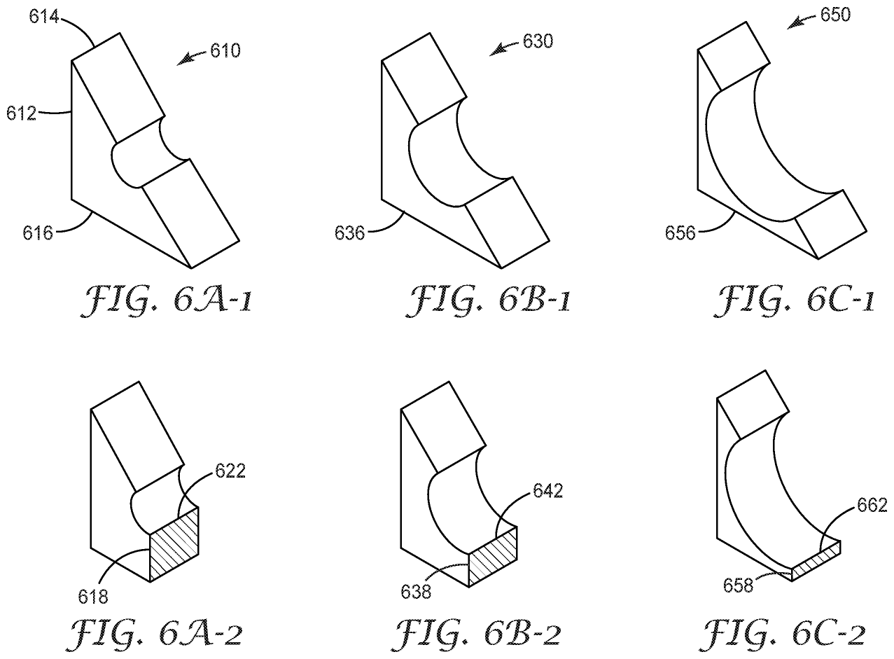

The shape of magnetizable particles 450 causes magnetizable particles to orient in the Z direction such that defect 452 is not in contact with backing 410, and a cutting face 454 is oriented in a downweb direction 414. This orientation occurs, as discusses in greater detail with respect to FIGS. 5 and 6, because of the net magnetic torque experienced by each magnetizable particle 450.

In general, applied magnetic fields used in practice of the present disclosure have a field strength in the region of the magnetizable particles being affected (e.g., attracted and/or oriented) of at least about 10 gauss (1 mT), at least about 100 gauss (10 mT), or at least about 1000 gauss (0.1 T), although this is not a requirement.

Magnetic elements 402 and 404 are positioned such that magnetic force 430 is experienced by magnetic particles 450 substantially after particles 450 leave dispensing surface 440. In one embodiment, magnetic particles 450 do not substantially experience magnetic force 430 until after they contact backing 410. In an embodiment where magnetic particles 450 are dispensed without the influence of a magnetic field, the particles 450 have a tendency to land on the largest surface, and in a random orientation. When magnetic field 430 is then applied by magnetic elements 402 and 404, magnetic particles 450 will ‘stand up’ such that a thickness (e.g. thickness 230 of particles 200) contacts backing 410, such that cutting face 454 is aligned in a downweb direction, and such that particles 450 are substantially parallel to each other. In one embodiment, magnetic particles 450 contact backing 410 prior to a make coat layer or make coat precursor being applied.

The applied magnetic field can be provided by one or more permanent magnets and/or electromagnet(s), or a combination of magnets and ferromagnetic members, for example. Suitable permanent magnets include rare-earth magnets. The applied magnetic field can be static or variable (e.g., oscillating). The upper and/or lower magnetic elements (402, 404), each having north (N) and south (S) poles, may be monolithic or they may be composed of multiple component magnets and/or magnetizable bodies, for example. If comprised of multiple magnets, the multiple magnets in a given magnetic member can be contiguous and/or co-aligned (e.g., at least substantially parallel) with respect to their magnetic field lines where the component magnets closest approach each other. Magnets 402 and 404 may be retained in place by one or more retainers (not shown). While stainless steel 304 or an equivalent is suitable for retaining magnets 402, 404 in place, due to its non-magnetic character, magnetizable materials may also be used. Mild steel mounts may support the stainless steel retainers. The application of a magnetic field is not intended to be limited to the illustrated arrangement, however. A magnetic yoke is also envisioned in some embodiments that connects magnets 402 and 404. Additionally, in some embodiments a Halbach array of magnets may be suitable.

The downward sloping dispensing surface 440 may be inclined at any suitable angle, provided that the magnetizable particles can travel down the surface and be dispensed onto the web. Suitable angles may be in a range of from 15 to 60 degrees, although other angles may also be used. In some instances, it may be desirable to vibrate the downward sloping dispensing surface to facilitate particle movement.

The downward sloping dispensing surface may be constructed of any dimensionally stable material, that may be non-magnetizable. Examples include: metals such as aluminum; wood; and plastic.

Once the magnetizable particles are coated on to backing 410, the make layer precursor is at least partially cured at a curing station (not shown), so as to firmly retain the magnetizable particles in position. In some embodiments, additional magnetizable and/or non-magnetizable particles (e.g., filler abrasive particle and/or grinding aid particles) can be applied to the make layer precursor prior to curing.

In the case of a coated abrasive article, the curable binder precursor comprises a make layer precursor, and the magnetizable particles comprise magnetizable abrasive particles. A size layer precursor may be applied over the at least partially cured make layer precursor and the magnetizable abrasive particles, although this is not a requirement. If present, the size layer precursor is then at least partially cured at a second curing station, optionally with further curing of the at least partially cured make layer precursor. In some embodiments, a supersize layer is disposed on the at least partially cured size layer precursor.

FIG. 4B illustrates a schematic of a system 490 for aligning magnetically responsive particles on a backing. FIG. 4B illustrates a simple example of a single particle 492 on a backing 494. Backing 494 moves in a coating direction as indicated by arrow 495. As illustrated, magnetic elements 496, 497 generate a magnetic field 498 that acts on particle 492 after particle 492 has landed on backing 494.

Magnetic elements 496, 497 are positioned on opposite sides of a coating web, and offset with respect to coating web direction 495. In one embodiment, as illustrated in FIG. 4B, a first magnetic element 496 encountered by particle 492 is below backing 494, while a second magnetic element 497 is above backing 494. However, in another embodiment, particle 492 first experiences a magnetic element above the backing, and a second magnetic element below the backing. Other suitable configurations are also possible.

FIG. 5 is a diagram illustrating the effect of a magnetic field on an abrasive particle. Abrasive particle 500 is a magnetically responsive abrasive particle, including a magnetically responsive coating, for example. Abrasive particle 500 is illustrated as a rectangular prism for ease of understanding. However, similar principals would apple for abrasive particles of other shapes, such as abrasive particle 200, described above with respect to FIG. 2.

Abrasive particle 500 has a length 530, a width 540, and a thickness 550. When dropped onto a backing, abrasive particle 500 has a tendency to land as shown in position 510, with a largest surface area in contact with the backing. However, when a magnetic field 560 is applied, abrasive particle 500 experiences a torque that causes the largest dimension to align with the direction of the magnetic field, into second position 520.

FIGS. 6A-6C illustrate views of shaped abrasive particles in accordance with an embodiment of the present invention. 6A-1, 6B-1, and 6C-1 all illustrate triangular-shaped particles with defects of varying sizes. As illustrated, the defects of particles 610, 630 and 650 all have some curvature, however similar principals would apply to particles without such curvature, or with only some curvature. Each of particles 610, 630, and 650 are magnetically responsive particles including magnetically responsive material as either part of their composition or as an applied magnetic coating.

When subjected to a magnetic field, it was surprising to see that particles 610 and 630, illustrated in FIGS. 6A-1 and 6B-1, respectively, would orient in an upright position but particle 650 remained in a lay-flat position. At some point, the size of a concave defect in an abrasive particle stops allowing alignment in a desired orientation.

Simulations to understand why enlarging a defect in an abrasive particle were conducted to understand the behavior of particle 650 compared to particles 610 and 630. It had been expected that creating thinner cutting and base portions, as illustrated in the progression of FIGS. 6A-2, 6B-2 and 6C-2 would continue to result in abrasive particles that oriented in an upright position. It was surprising to find that abrasive particle 650 would remain in a lay-flat position when exposed to a magnetic field.

The presence of a defect causes particles 610, 630 and 650 to behave similar to an “L”-shaped particle with a cutting portion (e.g. the upright portion attached to cutting face 612) and a base portion (e.g. the lay-flat portion coupled to base 616). Both of the cutting portion and the base portion experiences a magnetic moment when in the presence of a magnetic field, applied as described with respect to FIGS. 4A and 4B, for example. Generally, the magnetic moment of the cutting portion tends to draw the abrasive particle into an upward position as opposed to a lay-flat position. This is because the aspect ratio, measured as the height 612 of the cutting portion divided by the thickness 614, favors alignment of the cutting face parallel to an applied magnetic field.

The experienced magnetic moment of the base portion 604 is correlated to the size of the defect in an abrasive particle. A cutaway view of the base portion of each of particles 610, 630 and 650 is illustrated in FIGS. 6A-2, 6B-2, and 6C-2, respectively.

As illustrated in the cutaway view of FIG. 6A-2, the base portion of particle 610 has a substantially equal width 618 and thickness 622, which causes it to have substantially no magnetic moment. This causes the magnetic moment of the cutting edge to control the response of particle 610 when exposed to a magnetic field, causing particle 610 to orient as illustrated in FIG. 6A-1.

As illustrated in the cutaway view of FIG. 6B-2, the base portion of particle 630 has a thickness 642 which is greater than a width 638. This causes a magnetic moment on the base portion that would favor the particle orienting in a lay-flat position. However, since the magnetic moment on the cutting portion, governed by the cutting edge and thickness which are unchanged when compared to FIG. 6A-2, is greater than the opposing magnetic moment on the base portion, the particle will still orient in an upright position, as illustrated in FIG. 6B-1.

As illustrated in the cutaway view of FIG. 6C-2, the width 658 is much smaller than the thickness 662 of abrasive particle 650. This causes a larger magnetic moment on the base portion, in favor of a lay-flat position, than the magnetic moment on the cutting portion that favors an upright position. This causes the particle of FIG. 6C-1 to lay flat instead of in an upright orientation as illustrated in FIG. 6C-1.

FIGS. 7A and 7B illustrate torque diagrams of abrasive particles experiencing a magnetic field. As illustrated in FIGS. 7A and 7B, the directional alignment of a magnetic field is also important for aligning particles correctly. The symmetry of the magnetic field lines in FIG. 7A indicate that the particle experiences no net magnetic torque about an axis normal to the 2D image, although the particle in is FIG. 7B does experience a net torque about an axis normal to the 2D image as a result of asymmetric field lines. As illustrated in FIG. 7A, the torque experienced by an abrasive particle 710 is near zero when a theoretical hypotenuse of the particle is aligned with the magnetic field. In contrast, the torque is increased when the cutting face is in line with the magnetic field and the theoretical hypotenuse is rotated 45° relative to the magnetic fields, as illustrated for abrasive particle 720.

Additional simulations were conducted on additional shapes with differing defect designs to further understand the torque experienced by different shaped particles when subjected to a magnetic field. The magnetic modeling was done using 2.5D modeling. Profiles of investigated shapes were fit within a unit circle. All data was normalized to the torque experienced by a bar-shaped profile with an aspect ratio of about 10:1.

TABLE 1

| | rod | rod (width | equilateral | |
|---|---|---|---|---|
| | (reference) | of 0.2) | triangle | circle |
| Shape | [symbol] | [symbol] | [symbol] | [symbol] |
| Torque | 1.0 | 0.999 | 0.0 | 0.0 |
| | | Right | right triangle | Right triangle |
| | square | triangle | small defect | larger defect |
| Shape | [symbol] | [symbol] | [symbol] | [symbol] |
| Torque | 0.0 | 0.545 | 0.578 | 0.609 |
| | 120° | 120° Triangle | 120° Triangle | |
| | Triangle | small defect | larger defect | |
| Shape | [symbol] | [symbol] | [symbol] | |
| Torque | 0.730 | 0.737 | 0.768 | |

As illustrated in FIG. 1, the presence of a concave defect increases the relative torque experienced on an abrasive particle as compared to

Further modeling of different shapes is also described in the Examples below.

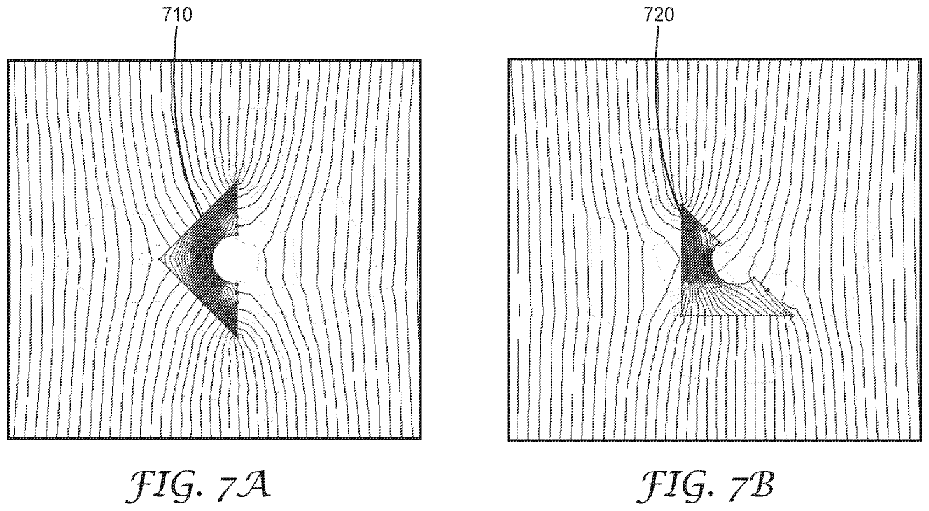

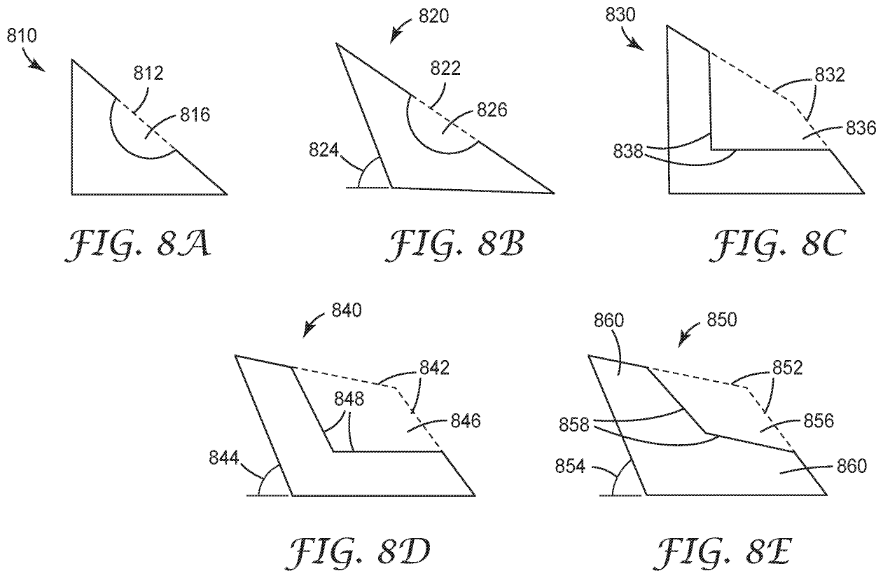

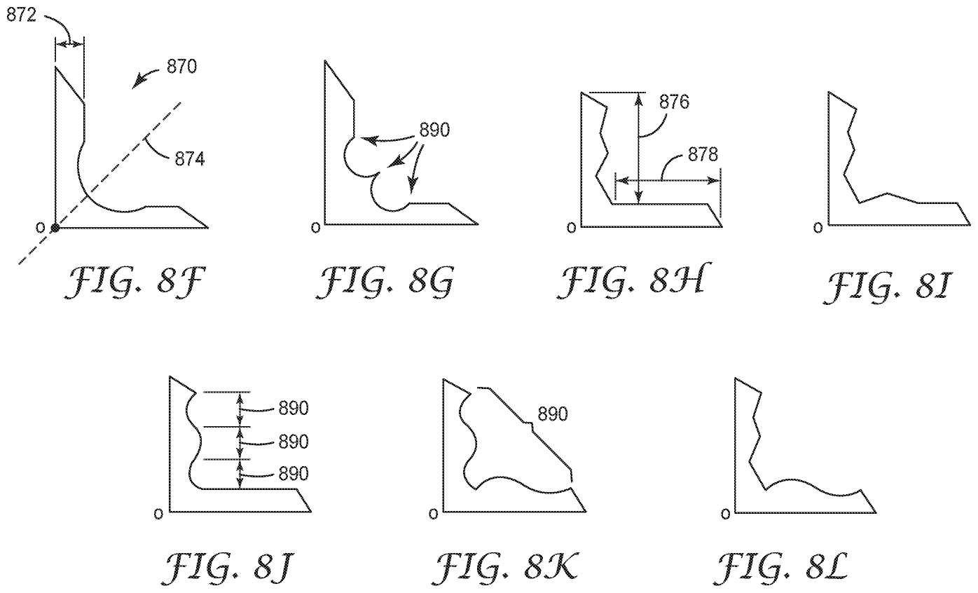

FIGS. 8A-8L illustrate shaped abrasive particles in accordance with an embodiment of the present invention. While the majority of embodiments discussed so far have referred to the example case of a right triangle shaped abrasive particle with a defect located on a theoretical hypotenuse, other shapes and designs are also expressly contemplated.

FIG. 8A illustrates a right triangle shaped abrasive particle 810 with a theoretical hypotenuse 812. A defect 816 has curvature.

FIG. 8B illustrates an obtuse triangle shaped abrasive particle 820 with a theoretical hypotenuse 822. Defect 826 is curved. Particle 820 has a rake angle 824.

FIG. 8C illustrates a quadrilateral shaped particle 830 with theoretical edges 832. Particle 830 has a defect 836 defined by defect edges 838. As illustrated, defect edges 838 are not connected with either a cutting face or a base face of particle 830.

FIG. 8D illustrates a quadrilateral shaped particle 840 with theoretical edges 842. Particle 840 has a defect 846 defined by defect edges 848. As illustrated, defect edges 848 are not connected with either a cutting face or a base face of particle 840. Particle 840 has a rake angle 844.

FIG. 8E illustrates a quadrilateral shaped particle 850 with theoretical edges 852. Particle 850 has a defect 856 defined by defect edges 858. Defect edges 858, as illustrated in FIG. 8E are not parallel to cutting face or base face of particle 850, such that each of the cutting portion and base portions have a varying thickness 860. As illustrated, defect edges 858 are not connected with either a cutting face or a base face of particle 850. Particle 850 has a rake angle 854.

FIGS. 8A-8E illustrate particle shapes with relatively regular shaped convex defects. However, it is expressly contemplated that other particle shapes may achieve similar results to those discussed above. For example, FIGS. 8F-8L illustrate additional particle shapes. However, FIGS. 8A-8L are not exhaustive, but only examples of particle shapes that may be suitable.

As described above, particles described herein can be considered to have a cutting portion, which includes a cutting face and a cutting edge, and a base portion, which includes a base edge that will couple to a backing. Examples of particles described thus far have contemplated particles where the cutting edge and the base edge are reflections of each other across a line of symmetry. As illustrated in FIG. 8F, for symmetric particles, a line of symmetry 874 extends through an origin, O. A benefit of a symmetric particle is that either edge AO or edge BO can serve as the cutting edge or the base edge, allowing for easier alignment of magnetically coated particles using magnetic fields. However, alignment can also be achieved for nonsymmetrical particles.

In many embodiments, it is desired to keep a ‘width’ of the cutting portion relatively constant. This allows the cutting face to continue to have a sharp cutting edge as the particle wears down. In contrast to traditional triangular-shaped particles, which experience an increasing width as the particle wears down, shapes like particle 870 will maintain a width 872 as the particle wears down from A to O.

Particles can, however, be considered as a cutting face, extending from A to O, and a base face, extending from O to B. The remaining perimeter of the particle, connecting A to B, can have a variety of different configurations.

For example, as illustrated in FIG. 8F, the perimeter can have multiple straight portions and a curved portion. At least two straight portions are parallel to either the cutting face or the base face. The particle illustrated in FIG. 8F is symmetric, such that both cutting face and base face have a sharp edge at A and B, respectively. The perimeter bevels inward from A and B before connecting to a straight portion, and then a curved portion.

As illustrated in FIG. 8G, a perimeter portion connecting A to B can be more complicated, with multiple curved portions and multiple straight portions. And, as illustrated in the contrast between FIGS. 8H and 8I, one portion 878 of an interior perimeter can be flat while another portion 876 includes multiple protrusions. The protrusions can have sharp edges, as illustrated in FIGS. 8H, 8I and 8L, or can be curved, as illustrated in FIGS. 8J, 8K and 8L.

As illustrated by reference numeral 890 in FIGS. 8G, 8J and 8K, abrasive particles can be described as having two regular faces AO and OB. The remaining perimeter of the abrasive particles illustrated in FIGS. 8F-8L include edges with one or more discontinuities 890, where the discontinuity is either a convex or concave discontinuity. As used herein, the term discontinuity includes both concave or convex features with sharp and rounded edges.

As illustrated in FIGS. 8A-8L, embodiments described herein involve magnetically responsive particles. The magnetically responsive particles are shaped such that, when exposed to a suitable magnetic field, the particles will orient such that their bases are parallel to each other, with the base in contact with, or parallel to, a backing. The particles will also orient such that their faces are also parallel to each other. For many embodiments described herein, the particles include a sharp edge on a cutting face, although sharp tips are also contemplated.

Particles described herein can be characterized as having two portions, a cutting portion and a base portion. The cutting portion and the base portion are connected and can be imagined as forming two edges of a triangle. The cutting portion and the base portion may join at a 90° angle, or may join such that the particle has a controlled rake angle between −60° and 60°.

The cutting portion and the base portion, in some embodiments, are similarly shaped such that either can serve as the cutting portion or the base portion. The base portion is designed to be parallel to, and fixed to, a backing. When the base portion is fixed to the backing, the cutting portion will be angled away from the backing, at an angle anywhere between 30°-129° with respect to the backing.

A cross-sectional area of the cutting portion is at least somewhat constant over a portion of the height of the cutting portion, in many embodiments, with the exception of a beveled portion that ends in the sharp edge that contacts a workpiece.

The ratio of the height to the maximum thickness of the cutting portion is between 1.5 and 20. The ratio of the length of the base portion to the average width of the base portion is between 2 and 10. The width of the cutting edge is between 10% and 1000% of the height of the cutting edge.

The particles described herein are all envisioned to be responsive to a magnetic field. For example, the particles may include magnetic material or may have a magnetic coating applied before or after firing. The magnetic responsiveness allows the particles to align in a preferred alignment when exposed to a suitable magnetic field. The particles are designed to experience a magnetic torque that is greater than a force of gravity on the particle, causing the particle to ‘stand up’ with a base edge facing a backing. The aspect ratio of both the cutting portion and the base portion need to be in a range such that the particles are aligned in a 90° orientation and are standing upright.

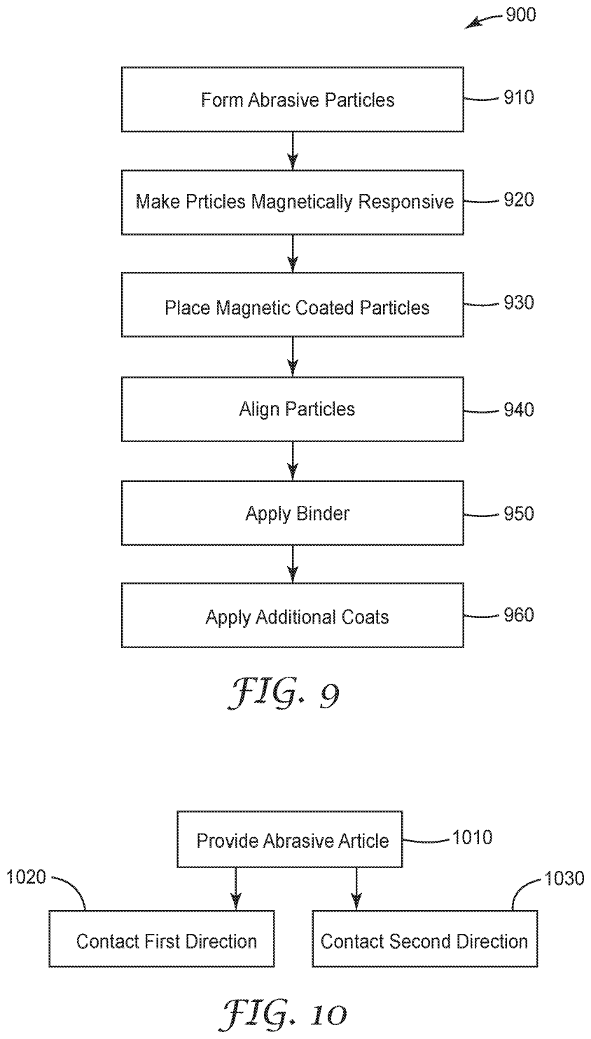

FIG. 9 illustrates a method of making a coated abrasive article in accordance with an embodiment of the present invention. The method of FIG. 9 may be suitable for forming any of the particles described in FIG. 2-4 or 6-8. Such a method may also be suitable for forming particles of other shapes. Additionally, while method 900 is described as a sequential set of steps, it is expressly contemplated that, for some applications, the steps described below may occur in a different order. For example, the steps of 930, 940 and 950 may occur in different orders depending on the particle, binder or coating compositions, for example.

In block 910, abrasive particles are formed. The abrasive particles may be formed with magnetic material such that they are magnetically responsive, in one embodiment. In another embodiment, the abrasive particles are formed such that they are substantially non-responsive to a magnetic field, and then are coated with a magnetically responsive coating material.

Abrasive particles are formed, in step 910, with a shape that experiences a net magnetic torque that causes the particles, when exposed to a magnetic field, will cause the particles to orient such that a majority of cutting faces the abrasive particles are aligned with each other. Additionally, particles are aligned such that a majority of bases are in contact with, or directly joinable to, a backing material.

In some embodiments, each abrasive particle can be characterized as having two substantially similarly shaped faces separated by a thickness. Each face has a cutting edge that extends from a first point to a second point. Each face also has a base edge that extends from the second point to a third point. The first point, along the thickness, defines a cutting edge. The first point and the third point are connected by the remaining edge or edges of a polygonal shape. For example, as illustrated in FIGS. 2A and 2B, a third edge represents a theoretical hypotenuse to complete a triangle with the cutting edge and the base edge. Or, as illustrated in FIGS. 8A-8L, the polygonal shape could also be a parallelogram.

The theoretical polygonal shape of the abrasive particle can be characterized by a void space that extends from at least one edge, other than the cutting edge or the base edge, into the interior of the theoretical polygonal shape. The void space, in some embodiments, causes the abrasive particle to experience a net magnetic torque that causes the particle to align such that the two parallel faces are perpendicular to a backing of an abrasive article. In some embodiments, the void space causes the abrasive particle to orient such that a height of the particle, represented by a distance between two parallel lines, one being the base edge and one including the first point, is in line with a magnetic field. In some embodiments, the abrasive particle has at least one line of symmetry that extends diagonally through the second point.

While many embodiments discussed herein envision a particle with parallel surfaces, other shapes are also expressly contemplated. Additionally, while a cutting edge is described, it is also contemplated that a cutting tip may be present in some embodiments.

Abrasive particles can be formed from many suitable materials or combinations of materials. For example, shaped abrasive particle can comprise a ceramic material or a polymeric material. Useful ceramic materials include, for example, fused aluminum oxide, heat treated aluminum oxide, white fused aluminum oxide, ceramic aluminum oxide materials such as those commercially available as 3M CERAMIC ABRASIVE GRAIN from 3M Company of St. Paul, Minn., alpha-alumina, zirconia, stabilized zirconia, mullite, zirconia toughened alumina, spinel, aluminosilicates (e.g., mullite, cordierite), perovskite, silicon carbide, silicon nitride, titanium carbide, titanium nitride, aluminum carbide, aluminum nitride, zirconium carbide, zirconium nitride, iron carbide, aluminum oxynitride, silicon aluminum oxynitride, aluminum titanate, tungsten carbide, tungsten nitride, steatite, diamond, cubic boron nitride, sol-gel derived ceramics (e.g., alumina ceramics doped with an additive), silica (e.g., quartz, glass beads, glass bubbles and glass fibers) and the like, or a combination thereof. Examples of sol-gel derived crushed ceramic particles can be found in U.S. Pat. No. 4,314,827 (Leitheiser et al.), U.S. Pat. No. 4,623,364 (Cottringer et al.); U.S. Pat. No. 4,744,802 (Schwabel), U.S. Pat. No. 4,770,671 (Monroe et al.); and U.S. Pat. No. 4,881,951 (Monroe et al.). A modifying additive can function to enhance some desirable property of the abrasive or increase the effectiveness of the subsequent sintering step. Modifying additives or precursors of modifying additives can be in the form of soluble salts, typically water soluble salts. They typically consist of a metal-containing compound and can be a precursor of oxide of magnesium, zinc, iron, silicon, cobalt, nickel, zirconium, hafnium, chromium, calcium, strontium, yttrium, praseodymium, samarium, ytterbium, neodymium, lanthanum, gadolinium, cerium, dysprosium, erbium, titanium, and mixtures thereof. The particular concentrations of these additives that can be present in the abrasive dispersion can be varied based on skill in the art. Further details concerning methods of making sol-gel-derived abrasive particles can be found in, for example, U.S. Pat. No. 4,314,827 (Leitheiser), U.S. Pat. No. 5,152,917 (Pieper et al.), U.S. Pat. No. 5,213,591 (Celikkaya et al.), U.S. Pat. No. 5,435,816 (Spurgeon et al.), U.S. Pat. No. 5,672,097 (Hoopman et al.), U.S. Pat. No. 5,946,991 (Hoopman et al.), U.S. Pat. No. 5,975,987 (Hoopman et al.), and U.S. Pat. No. 6,129,540 (Hoopman et al.), and in U.S. Publ. Pat. Appln. Nos. 2009/0165394 A1 (Culler et al.) and 2009/0169816 A1 (Erickson et al.).

Shaped abrasive particles that include a polymeric material can be characterized as soft abrasive particles. Soft shaped abrasive particles can include any suitable material or combination of materials. For example, the soft shaped abrasive particles can include a reaction product of a polymerizable mixture including one or more polymerizable resins. The one or more polymerizable resins are chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, a drying oil, or mixtures thereof. The polymerizable mixture can include additional components such as a plasticizer, an acid catalyst, a cross-linker, a surfactant, a mild-abrasive, a pigment, a catalyst and an antibacterial agent.

Where multiple components are present in the polymerizable mixture, those components can account for any suitable weight percentage of the mixture. For example, the polymerizable resin or resins, may be in a range of from about 35 wt % to about 99.9 wt % of the polymerizable mixture, about 40 wt % to about 95 wt %, or less than, equal to, or greater than about 35 wt %, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99.9 wt %.

If present, the cross-linker may be in a range of from about 2 wt % to about 60 wt % of the polymerizable mixture, from about 5 wt % to about 10 wt %, or less than, equal to, or greater than about 2 wt %, 3, 4, 5, 6, 7, 8, 9, 10, 11, 12, 13, 14, or about 15 wt %. Examples of suitable cross-linkers include a cross-linker available under the trade designation CYMEL 303 LF, of Allnex USA Inc., Alpharetta, Ga., USA; or a cross-linker available under the trade designation CYMEL 385, of Allnex USA Inc., Alpharetta, Ga., USA.

If present, the mild-abrasive may be in a range of from about 5 wt % to about 65 wt % of the polymerizable mixture, about 10 wt % to about 20 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or about 65 wt %. Examples of suitable mild-abrasives include a mild-abrasive available under the trade designation MINSTRON 353 TALC, of Imerys Talc America, Inc., Three Forks, Mont., USA; a mild-abrasive available under the trade designation USG TERRA ALBA NO. 1 CALCIUM SULFATE, of USG Corporation, Chicago, Ill., USA; Recycled Glass (40-70 Grit) available from ESCA Industries, Ltd., Hatfield, Pa., USA, silica, calcite, nepheline, syenite, calcium carbonate, or mixtures thereof.

If present, the plasticizer may be in a range of from about 5 wt % to about 40 wt % of the polymerizable mixture, about 10 wt % to about 15 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or about 40 wt %. Examples of suitable plasticizers include acrylic resins or styrene butadiene resins. Examples of acrylic resins include an acrylic resin available under the trade designation RHOPLEX GL-618, of DOW Chemical Company, Midland, Mich., USA; an acrylic resin available under the trade designation HYCAR 2679, of the Lubrizol Corporation, Wickliffe, Ohio, USA; an acrylic resin available under the trade designation HYCAR 26796, of the Lubrizol Corporation, Wickliffe, Ohio, USA; a polyether polyol available under the trade designation ARCOL LG-650, of DOW Chemical Company, Midland, Mich., USA; or an acrylic resin available under the trade designation HYCAR 26315, of the Lubrizol Corporation, Wickliffe, Ohio, USA. An example of a styrene butadiene resin includes a resin available under the trade designation ROVENE 5900, of Mallard Creek Polymers, Inc., Charlotte, N.C., USA.

If present, the acid catalyst may be in a range of from 1 wt % to about 20 wt % of the polymerizable mixture, about 5 wt % to about 10 wt %, or less than, equal to, or greater than about 1 wt %, 2, 3, 4, 5, 6, 7, 8, 9, 10, 11, 12, 13, 14, 15, 16, 17, 18, 19, or about 20 wt %. Examples of suitable acid catalysts include a solution of aluminum chloride or a solution of ammonium chloride.

If present, the surfactant can be in a range of from about 0.001 wt % to about 15 wt % of the polymerizable mixture about 5 wt % to about 10 wt %, less than, equal to, or greater than about 0.001 wt %, 0.01, 0.5, 1, 2, 3, 4, 5, 6, 7, 8, 9, 10, 11, 12, 13, 14, or about 15 wt %. Examples of suitable surfactants include a surfactant available under the trade designation GEMTEX SC-85-P, of Innospec Performance Chemicals, Salisbury, N.C., USA; a surfactant available under the trade designation DYNOL 604, of Air Products and Chemicals, Inc., Allentown, Pa., USA; a surfactant available under the trade designation ACRYSOL RM-8W, of DOW Chemical Company, Midland, Mich., USA; or a surfactant available under the trade designation XIAMETER AFE 1520, of DOW Chemical Company, Midland, Mich., USA.

If present, the antimicrobial agent may be in a range of from 0.5 wt % to about 20 wt % of the polymerizable mixture, about 10 wt % to about 15 wt %, or less than, equal to, or greater than about 0.5 wt %, 1, 2, 3, 4, 5, 6, 7, 8, 9, 10, 11, 12, 13, 14, 15, 16, 17, 18, 19, or about 20 wt %. An example of a suitable antimicrobial agent includes zinc pyrithione.

If present, the pigment may be in a range of from about 0.1 wt % to about 10 wt % of the polymerizable mixture, about 3 wt % to about 5 wt %, less than, equal to, or greater than about 0.1 wt %, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, or about 10 wt %. Examples of suitable pigments include a pigment dispersion available under the trade designation SUNSPERSE BLUE 15, of Sun Chemical Corporation, Parsippany, N.J., USA; a pigment dispersion available under the trade designation SUNSPERSE VIOLET 23, of Sun Chemical Corporation, Parsippany, N.J., USA; a pigment dispersion available under the trade designation SUN BLACK, of Sun Chemical Corporation, Parsippany, N.J., USA; or a pigment dispersion available under the trade designation BLUE PIGMENT B2G, of Clariant Ltd., Charlotte, N.C., USA.

Shaped abrasive particle is a monolithic abrasive particle. As shown, shaped abrasive particle is free of a binder and is not an agglomeration of abrasive particles held together by a binder or other adhesive material.

Shaped abrasive particle can be formed in many suitable manners for example, the shaped abrasive particle can be made according to a multi-operation process. The process can be carried out using any material or precursor dispersion material. Briefly, for embodiments where shaped abrasive particles are monolithic ceramic particles, the process can include the operations of making either a seeded or non-seeded precursor dispersion that can be converted into a corresponding (e.g., a boehmite sol-gel that can be converted to alpha alumina); filling one or more mold cavities having the desired outer shape of shaped abrasive particle with a precursor dispersion; drying the precursor dispersion to form precursor shaped abrasive particle; removing the precursor shaped abrasive particle from the mold cavities; calcining the precursor shaped abrasive particle to form calcined, precursor shaped abrasive particle; and then sintering the calcined, precursor shaped abrasive particle to form shaped abrasive particle. The process will now be described in greater detail in the context of alpha-alumina-containing shaped abrasive particle. In other embodiments, the mold cavities may be filled with a melamine to form melamine shaped abrasive particles.

The process can include the operation of providing either a seeded or non-seeded dispersion of a precursor that can be converted into ceramic. In examples where the precursor is seeded, the precursor can be seeded with an oxide of an iron (e.g., FeO). The precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the precursor dispersion in some embodiments contains from 30 percent to 50 percent, or 40 percent to 50 percent solids by weight.

Examples of suitable precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area.

The physical properties of the resulting shaped abrasive particle can generally depend upon the type of material used in the precursor dispersion. As used herein, a “gel” is a three-dimensional network of solids dispersed in a liquid.

The precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of an oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the precursor dispersion can be varied.

The introduction of a modifying additive or precursor of a modifying additive can cause the precursor dispersion to gel. The precursor dispersion can also be induced to gel by application of heat over a period of time to reduce the liquid content in the dispersion through evaporation. The precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the precursor dispersion to produce a more stable hydrosol or colloidal precursor dispersion. Suitable peptizing agents are monoprotic acids or acid compounds such as acetic acid, hydrochloric acid, formic acid, and nitric acid. Multiprotic acids can also be used, but they can rapidly gel the precursor dispersion, making it difficult to handle or to introduce additional components. Some commercial sources of boehmite contain an acid titer (such as absorbed formic or nitric acid) that will assist in forming a stable precursor dispersion.

The precursor dispersion can be formed by any suitable means; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

A further operation can include providing a mold having at least one mold cavity, or a plurality of cavities formed in at least one major surface of the mold. In some examples, the mold is formed as a production tool, which can be, for example, a belt, a sheet, a continuous web, a coating roll such as a rotogravure roll, a sleeve mounted on a coating roll, or a die. In one example, the production tool can include polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one example, the entire tooling is made from a polymeric or thermoplastic material. In another example, the surfaces of the tooling in contact with the precursor dispersion while the precursor dispersion is drying, such as the surfaces of the plurality of cavities, include polymeric or thermoplastic materials, and other portions of the tooling can be made from other materials. A suitable polymeric coating can be applied to a metal tooling to change its surface tension properties, for example.

A polymeric or thermoplastic production tool can be replicated off a metal master tool. The master tool can have the inverse pattern of that desired for the production tool. The master tool can be made in the same manner as the production tool. In one example, the master tool is made out of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities can be from an opening in the top surface or bottom surface of the mold. In some examples, the cavities can extend for the entire thickness of the mold. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make shaped abrasive particle. The depth dimension is equal to the perpendicular distance from the top surface to the lowermost point on the bottom surface. The depth of a given cavity can be uniform or can vary along its length and/or width. The cavities of a given mold can be of the same shape or of different shapes.

A further operation involves filling the cavities in the mold with the precursor dispersion (e.g., by a conventional technique). In some examples, a knife roll coater or vacuum slot die coater can be used. A mold release agent can be used to aid in removing the particles from the mold if desired. Examples of mold release agents include oils such as peanut oil or mineral oil, fish oil, silicones, polytetrafluoroethylene, zinc stearate, and graphite. In general, a mold release agent such as peanut oil, in a liquid, such as water or alcohol, is applied to the surfaces of the production tooling in contact with the precursor dispersion such that from about 0.1 mg/in² (0.6 mg/cm²) to about 3.0 mg/in² (20 mg/cm²), or from about 0.1 mg/in² (0.6 mg/cm²) to about 5.0 mg/in² (30 mg/cm²), of the mold release agent is present per unit area of the mold when a mold release is desired. In some embodiments, the top surface of the mold is coated with the precursor dispersion. The precursor dispersion can be pumped onto the top surface.

In a further operation, a scraper or leveler bar can be used to force the precursor dispersion fully into the cavity of the mold. The remaining portion of the precursor dispersion that does not enter the cavity can be removed from the top surface of the mold and recycled. In some examples, a small portion of the precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the precursor dispersion extends substantially beyond the top surface.

In those examples where it is desired to have the exposed surfaces of the cavities result in planar faces of the shaped abrasive particles, it can be desirable to overfill the cavities (e.g., using a micronozzle array) and slowly dry the precursor dispersion.

A further operation involves removing the volatile component to dry the dispersion. The volatile component can be removed by fast evaporation rates. In some examples, removal of the volatile component by evaporation occurs at temperatures above the boiling point of the volatile component. An upper limit to the drying temperature often depends on the material the mold is made from. For polypropylene tooling, the temperature should be less than the melting point of the plastic. In one example, for a water dispersion of from about 40 to 50 percent solids and a polypropylene mold, the drying temperatures can be from about 90° C. to about 165° C., or from about 105° C. to about 150° C., or from about 105° C. to about 120° C. Higher temperatures can lead to improved production speeds but can also lead to degradation of the polypropylene tooling, limiting its useful life as a mold.

During drying, the precursor dispersion shrinks, often causing retraction from the cavity walls. For example, if the cavities have planar walls, then the resulting shaped abrasive particle can tend to have at least three concave major sides. It is presently discovered that by making the cavity walls concave (whereby the cavity volume is increased) it is possible to obtain shaped abrasive particle that have at least three substantially planar major sides. The degree of concavity generally depends on the solids content of the precursor dispersion.

A further operation involves removing resultant precursor shaped abrasive particle from the mold cavities. The precursor shaped abrasive particle can be removed from the cavities by using the following processes alone or in combination on the mold: gravity, vibration, ultrasonic vibration, vacuum, or pressurized air to remove the particles from the mold cavities.

The precursor shaped abrasive particle can be further dried outside of the mold. If the precursor dispersion is dried to the desired level in the mold, this additional drying step is not necessary. However, in some instances it can be economical to employ this additional drying step to minimize the time that the precursor dispersion resides in the mold. The precursor shaped abrasive particle will be dried from 10 to 480 minutes, or from 120 to 400 minutes, at a temperature from 50° C. to 160° C., or 120° C. to 150° C.

A further operation involves calcining the precursor shaped abrasive particle. During calcining, essentially all the volatile material is removed, and the various components that were present in the precursor dispersion are transformed into metal oxides. The precursor shaped abrasive particle are generally heated to a temperature from 400° C. to 800° C. and maintained within this temperature range until the free water and over 90 percent by weight of any bound volatile material are removed. In an optional step, it can be desirable to introduce the modifying additive by an impregnation process. A water-soluble salt can be introduced by impregnation into the pores of the calcined, precursor shaped abrasive particle. Then the precursor shaped abrasive particle are pre-fired again.

A further operation can involve sintering the calcined, precursor shaped abrasive particle to form the abrasive particles. In some examples where the precursor includes rare earth metals, however, sintering may not be necessary. Prior to sintering, the calcined, precursor shaped abrasive particle are not completely densified and thus lack the desired hardness to be used as shaped abrasive particle. Sintering takes place by heating the calcined, precursor shaped abrasive particle to a temperature of from 1000° C. to 1650° C. The length of time for which the calcined, precursor shaped abrasive particle can be exposed to the sintering temperature to achieve this level of conversion depends upon various factors, but from five seconds to 48 hours is possible.

In another embodiment, the duration of the sintering step ranges from one minute to 90 minutes. After sintering, the shaped abrasive particle 14 can have a Vickers hardness of 10 GPa (gigaPascals), 16 GPa, 18 GPa, 20 GPa, or greater.

Additional operations can be used to modify the described process, such as, for example, rapidly heating the material from the calcining temperature to the sintering temperature, and centrifuging the precursor dispersion to remove sludge and/or waste. Moreover, the process can be modified by combining two or more of the process steps if desired.

To form soft shaped abrasive particle the polymerizable mixtures described herein can be deposited in a cavity. The cavity can have a shape corresponding to the negative impression of the desired shaped abrasive particle. After the cavity is filled to the desired degree, the polymerizable mixture is cured therein. Curing can occur at room temperature (e.g., about 25° C.) or at any temperature above room temperature. Curing can also be accomplished by exposing the polymerizable mixture to a source of electromagnetic radiation or ultraviolet radiation.

Shaped abrasive particles can be independently sized according to an abrasives industry recognized specified nominal grade. Abrasive industry recognized grading standards include those promulgated by ANSI (American National Standards Institute), FEPA (Federation of European Producers of Abrasives), and JIS (Japanese Industrial Standard). ANSI grade designations (i.e., specified nominal grades) include, for example: ANSI 4, ANSI 6, ANSI 8, ANSI 16, ANSI 24, ANSI 36, ANSI 46, ANSI 54, ANSI 60, ANSI 70, ANSI 80, ANSI 90, ANSI 100, ANSI 120, ANSI 150, ANSI 180, ANSI 220, ANSI 240, ANSI 280, ANSI 320, ANSI 360, ANSI 400, and ANSI 600. FEPA grade designations include F4, F5, F6, F7, F8, F10, F12, F14, F16, F18, F20, F22, F24, F30, F36, F40, F46, F54, F60, F70, F80, F90, F100, F120, F150, F180, F220, F230, F240, F280, F320, F360, F400, F500, F600, F800, F1000, F1200, F1500, and F2000. JIS grade designations include JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS600, JIS800, JIS1000, JIS1500, JIS2500, JIS4000, JIS6000, JIS8000, and JIS10,000.

Any one of the surfaces of a shaped abrasive particle can include a surface feature such as a substantially planar surface; a substantially planar surface having a triangular, rectangular, hexagonal, or other polygonal perimeter; a concave surface; a convex surface; an aperture; a ridge; a line or a plurality of lines; a protrusion; a point; or a depression. The surface feature can be chosen to change the cut rate, reduce wear of the formed abrasive particles, or change the resulting finish of an abrasive article. Additionally, a shaped abrasive particle 300 can have a combination of the above shape elements (e.g., convex sides, concave sides, irregular sides, and planar sides).

The shaped abrasive particles can have at least one sidewall, which may be a sloping sidewall. In some embodiments, more than one (for example two or three) sloping sidewall can be present and the slope or angle for each sloping sidewall may be the same or different. In other embodiments, the sidewall can be minimized for particles where the first and the second faces taper to a thin edge or point where they meet instead of having a sidewall. The sloping sidewall can also be defined by a radius, R (as illustrated in FIG. 5B of US Patent Application No. 2010/0151196). The radius, R, can be varied for each of the sidewalls.

Specific examples of shaped particles having a ridge line include roof-shaped particles, for example particles as illustrated, in FIG. 4A to 4C of WO 2011/068714. Preferred, roof-shaped particles include particles having the shape of a hip roof, or hipped roof (a type of roof wherein any sidewalls facets present slope downwards from the ridge line to the first side. A hipped roof typically does not comprise vertical sidewall(s) or facet(s)).

Shaped abrasive particles can have one or more shape features selected from: an opening (preferably one extending or passing through the first and second side); at least one recessed (or concave) face or facet; at least one face or facet which is shaped outwardly (or convex); at least one side comprising a plurality of grooves; at least one fractured surface; a cavity, a low roundness factor; or a combination of one or more of said shape features.

Shaped abrasive particles 300 can also comprise a plurality of ridges on their surfaces. The plurality of grooves (or ridges) can be formed by a plurality of ridges (or grooves) in the bottom surface of a mold cavity that have been found to make it easier to remove the precursor shaped abrasive particles from the mold.

The plurality of grooves (or ridges) is not particularly limited and can, for example, comprise parallel lines which may or may not extend completely across the side. Preferably, the parallel lines intersect with the perimeter along a first edge at a 90° angle. The cross-sectional geometry of a groove or ridge can be a truncated triangle, triangle, or other geometry as further discussed in the following. In various embodiments of the invention, the depth, of the plurality of grooves can be between about 1 micrometer to about 400 micrometers.

According to another embodiment the plurality of grooves comprises a cross hatch pattern of intersecting parallel lines which may or may not extend completely across the face. In various embodiments, the cross hatch pattern can use intersecting parallel or non-parallel lines, various percent spacing between the lines, arcuate intersecting lines, or various cross-sectional geometries of the grooves. In other embodiments the number of ridges (or grooves) in the bottom surface of each mold cavity can be between 1 and about 100, or between 2 to about 50, or between about 4 to about 25 and thus form a corresponding number of grooves (or ridges) in the shaped abrasive particles.

Methods for making shaped abrasive particles having at least one sloping sidewall are for example described in US Patent Application Publication No. 2009/0165394. Methods for making shaped abrasive particles having an opening are for example described in US Patent Application Publication No. 2010/0151201 and 2009/0165394. Methods for making shaped abrasive particles having grooves on at least one side are for example described in US Patent Application Publication No. 2010/0146867. Methods for making dish-shaped abrasive particles are for example described in US Patent Application Publication Nos. 2010/0151195 and 2009/0165394. Methods for making shaped abrasive particles with low Roundness Factor are for example described in US Patent Application Publication No. 2010/0319269. Methods for making shaped abrasive particles with at least one fractured surface are for example described in US Patent Application Publication Nos. 2009/0169816 and 2009/0165394. Methods for making abrasive particles wherein the second side comprises a vertex (for example, dual tapered abrasive particles) or a ridge line (for example, roof shaped particles) are for example described in WO 2011/068714.

In block 920, the abrasive particles are made to be magnetically responsive. In one embodiment, making particles magnetically responsive comprises coating non-magnetically responsive particles with a magnetically responsive coating. However, in another embodiment, the particles are formed with magnetically responsive material, such that steps 910 and 920 are accomplished substantially simultaneously, for example as recited in co-owned provisional patent U.S. 62/914,778, filed on Oct. 14, 2019.

In addition to the materials already described, at least one magnetic material may be included within or coated to shaped abrasive particle. Examples of magnetic materials include iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (about 85:9:6 by weight) marketed as Sendust alloy; Heusler alloys (e.g., Cu₂MnSn); manganese bismuthide (also known as Bismanol); rare earth magnetizable materials such as gadolinium, dysprosium, holmium, europium oxide, alloys of neodymium, iron and boron (e.g., Nd₂Fe₁₄B), and alloys of samarium and cobalt (e.g., SmCo₅); MnSb; MnOFe₂₀₃; Y₃Fe₅O₁₂; CrO₂; MnAs; ferrites such as ferrite, magnetite; zinc ferrite; nickel ferrite; cobalt ferrite, magnesium ferrite, barium ferrite, and strontium ferrite; yttrium iron garnet; and combinations of the foregoing. In some embodiments, the magnetizable material is an alloy containing 8 to 12 weight percent aluminum, 15 to 26 wt % nickel, 5 to 24 wt % cobalt, up to 6 wt % copper, up to 1% titanium, wherein the balance of material to add up to 100 wt % is iron. In some other embodiments, a magnetizable coating can be deposited on an abrasive particle 100 using a vapor deposition technique such as, for example, physical vapor deposition (PVD) including magnetron sputtering.

Including these magnetizable materials can allow shaped abrasive particle to be responsive a magnetic field. Any of shaped abrasive particles can include the same material or include different materials.

The magnetic coating may be a continuous coating, for example that coats an entire abrasive particle, or at least coats an entire surface of an abrasive particle. In another embodiment, a continuous coating refers to a coating present with no uncoated portions on the coated surface. In one embodiment, the coating is a unitary coating—formed of a single layer of magnetic material and not as discrete magnetic particulates. In one embodiment, the magnetic coating is provided on an abrasive particle while the particle is still in a mold cavity, such that the magnetic coating directly contacts an abrasive particle precursor surface. In one embodiment, the thickness of the magnetic coating is at most equal to, or preferably less than, a thickness of the abrasive particle. In one embodiment, the magnetic coating is not more than about 20 wt. % of the final particle, or not more than about 10 wt. % of the final particle, or not more than 5 wt. % of the final particle.

In block 930, the particles are aligned with respect to each other on a backing. Aligning the abrasive particles with respect to each other generally requires two steps. First, providing the magnetizable abrasive particles described herein on a substrate having a major surface. Second, applying a magnetic field to the magnetizable abrasive particles such that a majority of the magnetizable abrasive particles are oriented substantially perpendicular to the major surface.

Without application of a magnetic field, the resultant magnetizable abrasive particles may not have a magnetic moment, and the constituent abrasive particles, or magnetizable abrasive particles may be randomly oriented. However, when a sufficient magnetic field is applied the magnetizable abrasive particles will tend to align with the magnetic field. In favored embodiments, the ceramic particles have a major axis (e.g. aspect ratio of 2) and the major axis aligns parallel to the magnetic field. Preferably, a majority or even all of the magnetizable abrasive particles will have magnetic moments that are aligned substantially parallel to one another. As described above, abrasive particles described herein may have more than one magnetic moments, and will align with a net magnetic torque.

The magnetic field can be supplied by any external magnet (e.g., a permanent magnet or an electromagnet) or set of magnets. In some embodiments, the magnetic field typically ranges from 0.5 to 1.5 kOe. Preferably, the magnetic field is substantially uniform on the scale of individual magnetizable abrasive particles.

For production of abrasive articles, a magnetic field can optionally be used to place and/or orient the magnetizable abrasive particles prior to curing a binder (e.g., vitreous or organic) precursor to produce the abrasive article. The magnetic field may be substantially uniform over the magnetizable abrasive particles before they are fixed in position in the binder or continuous over the entire, or it may be uneven, or even effectively separated into discrete sections. Typically, the orientation of the magnetic field is configured to achieve alignment of the magnetizable abrasive particles according to a predetermined orientation.

As a result of this process, individual shaped abrasive particles are positioned on a backing such that abrasive particles are parallel to each other and have cutting faces facing in a downweb direction.

Examples of magnetic field configurations and apparatuses for generating them are described in U.S. Pat. No. 8,262,758 (Gao) and U.S. Pat. No. 2,370,636 (Carlton), U.S. Pat. No. 2,857,879 (Johnson), U.S. Pat. No. 3,625,666 (James), U.S. Pat. No. 4,008,055 (Phaal), U.S. Pat. No. 5,181,939 (Neff), and British (G. B.) Pat. No. 1 477 767 (Edenville Engineering Works Limited).

In block 940, the particles are adhered to a backing. Any abrasive article such as abrasive belt or abrasive disc can include a make coat to adhere shaped abrasive particles, or a blend of shaped abrasive particles and crushed abrasive particles, to backing.

In block 950, additional coatings are applied, such as a size coating or a supersize coating. The abrasive article may further include a size coat adhering the shaped abrasive particles to the make coat. The make coat, size coat, or both can include any suitable resin such as a phenolic resin, an epoxy resin, a urea-formaldehyde resin, an acrylate resin, an aminoplast resin, a melamine resin, an acrylated epoxy resin, a urethane resin, or mixtures thereof. Additionally, the make coat, size coat, or both can include a filler, a grinding aid, a wetting agent, a surfactant, a dye, a pigment, a coupling agent, an adhesion promoter, or a mixture thereof. Examples of fillers may include calcium carbonate, silica, talc, clay, calcium metasilicate, dolomite, aluminum sulfate, or a mixture thereof.

FIG. 10 illustrates a method of using an abrasive article in accordance with an embodiment of the present invention. Method 1010 can be used to abrade a number of different workpieces. Upon contact, one of the abrasive article and the workpiece is moved relative to one another in a direction of use and a portion of the workpiece is removed.

Examples of workpiece materials include metal, metal alloys, steel, steel alloys, aluminum exotic metal alloys, ceramics, glass, wood, wood-like materials, composites, painted surfaces, plastics, reinforced plastics, stone, and/or combinations thereof. The workpiece may be flat or have a shape or contour associated with it. Exemplary workpieces include metal components, plastic components, particleboard, camshafts, crankshafts, furniture, and turbine blades.

Abrasive articles according to the present disclosure are useful for abrading a workpiece. Methods of abrading range from snagging (i.e., high pressure high stock removal) to polishing (e.g., polishing medical implants with coated abrasive belts), wherein the latter is typically done with finer grades of abrasive particles. One such method includes the step of frictionally contacting an abrasive article (e.g., a coated abrasive article, a nonwoven abrasive article, or a bonded abrasive article) with a surface of the workpiece, and moving at least one of the abrasive article or the workpiece relative to the other to abrade at least a portion of the surface.

In block 1010, an abrasive article is provided. In one embodiment, the abrasive article includes a plurality of abrasive particles that are designed with a first direction of use and a second direction of use. For example, referring back to FIG. 3, moving an abrasive article in a first direction of use refers to moving an abrasive article in direction 302, such that a cutting face 320 encounters an abrasive article first. A second direction of use refers to moving an abrasive article in a direction opposite direction 302. According to various embodiments, a method of using an abrasive article such as abrasive belt or abrasive disc includes contacting shaped abrasive particles with a workpiece or substrate.

According to various embodiments, a cutting depth into the substrate or workpiece can be at least about 10 μm, at least about 20 μm, at least about 30 μm, at least about 40 μm, at least about 50 μm, or at least about 60 μm. A portion of the substrate or workpiece is removed by the abrasive article as a swarf.

In block 1020, the abrasive article is moved against a workpiece in a preferred direction of use is a first direction indicated as indicated as direction 302 in FIG. 3, for example.

According to various embodiments, the abrasive articles described herein can have several advantages when moved in a preferred direction of use. For example, at the same applied force, cutting speed, or a combination thereof, an amount of material removed from the workpiece, length of a swarf removed from the workpiece, depth of cut in the workpiece, surface roughness of the workpiece or a combination thereof is greater in the first direction than in any other second direction.

For example, at least about 10% more material is removed from the substrate or workpiece in the first direction of use, or at least about 15%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 100%, at least about 120%, at least about 130%, at least about 140%, at least about 150%. In some embodiments, about 15% to about 500% more material is removed in the first direction of use, or about 30% to about 70%, or about 40% to about 60%, or less than, equal to, or greater than about 15%, 20%, 25%, 30%, 35%, 40%, 45%, 50%, 55%, 60%, 65%, 70%, 75%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 205%, 210%, 215%, 220%, 225%, 230%, 235%, 240%, 245%, 250%, 255%, 260%, 265%, 270%, 275%, 280%, 285%, 290%, 295%, 300%, 305%, 310%, 315%, 320%, 325%, 330%, 335%, 340%, 345%, 350%, 355%, 360%, 365%, 370%, 375%, 380%, 385%, 390%, 395%, 400%, 405%, 410%, 415%, 420%, 425%, 430%, 435%, 440%, 445%, 450%, 455%, 460%, 465%, 470%, 475%, 480%, 485%, 490%, 495%, or about 500%. The amount of material removed can be in reference to an initial cut (e.g., the first cut of a cutting cycle) or a total cut (e.g., a sum of the amount of material removed over a set number of cutting cycles).

As a further example, a depth of cut into the substrate or workpiece may be at least about 10% deeper in the first direction of use, or at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 100%, at least about 120%, at least about 130%, at least about 140%, at least about 150%. In some embodiments, about 10% to about 500% deeper in the first direction of use, or about 30% to about 70%, or about 40% to about 60%, or less than, equal to, or greater than about 15%, 20%, 25%, 30%, 35%, 40%, 45%, 50%, 55%, 60%, 65%, 70%, 75%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 205%, 210%, 215%, 220%, 225%, 230%, 235%, 240%, 245%, 250%, 255%, 260%, 265%, 270%, 275%, 280%, 285%, 290%, 295%, 300%, 305%, 310%, 315%, 320%, 325%, 330%, 335%, 340%, 345%, 350%, 355%, 360%, 365%, 370%, 375%, 380%, 385%, 390%, 395%, 400%, 405%, 410%, 415%, 420%, 425%, 430%, 435%, 440%, 445%, 450%, 455%, 460%, 465%, 470%, 475%, 480%, 485%, 490%, 495%, or about 500%.

As a further example an arithmetical mean roughness value (Sa) of the workpiece or substrate cut by moving the abrasive article in first direction of use 202 or 304 can be higher than a corresponding substrate or workpiece cut under the exact same conditions but in the second direction of movement. For example, the surface roughness can be about 30% greater when the workpiece or substrate is cut in the first direction or about 40% greater, about 50% greater, about 60% greater, about 70% greater, about 80% greater, about 90% greater, about 100% greater, about 110% greater, about 120% greater, about 130% greater, about 140% greater, about 150% greater, about 160% greater, about 170% greater, about 180% greater, about 190% greater, about 200% greater, about 210% greater, about 220% greater, about 230% greater, about 240% greater, about 250% greater, about 260% greater, about 270% greater, about 280% greater, about 290% greater, about 300% greater, about 310% greater, about 320% greater, about 330% greater, about 340% greater, about 350% greater, about 360% greater, about 370% greater, about 380% greater, about 390% greater, about 400% greater, about 410% greater, about 420% greater, about 430% greater, about 440% greater, about 450% greater, about 460% greater, about 470% greater, about 480% greater, about 490% greater, or about 500% greater. The arithmetical mean roughness value can be in a range of from about 1000 to about 2000, about 1000 to about 1100, or less than, equal to, or greater than about 1000, 1050, 1100, 1150, 1200, 1250, 1300, 1350, 1400, 1450, 1500, 1550, 1600, 1650, 1700, 1750, 1800, 1850, 1900, 1950, or about 2000.

Alternatively, as illustrated in block 1030, it is possible for the abrasive article to be moved in a second direction that is different than direction of use 302. The second direction can be in a direction rotated about 1 degree to 360 degrees relative to direction of use 302, about 160 degrees to about 200 degrees, less than, equal to, or greater than about 1 degree, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 230, 240, 250, 260, 265, 270, 275, 280, 285, 290, 295, 300, 305, 310, 315, 320, 325, 330, 335, 340, 350, 355, or about 360 degrees.

Although it may be desirable to move the abrasive article in first direction of use 202 or 304, there are some reasons to move the abrasive article in a second direction of movement other than first direction of use 302. For example, contacting the substrate or workpiece with the abrasive article and moving the abrasive article in the second direction may be beneficial for finishing the substrate or workpiece. While not intending to be bound to any particular theory, the inventors hypothesize that movement in the second direction may expose the substrate or workpiece to an angle other than a rake angle of the abrasive particle, which is more suited for finishing applications.

In some embodiments, shaped abrasive particles described herein can be included in a random orbital sander or vibratory sander. In these embodiments, it may be desirable to have shaped abrasive particles be randomly oriented (e.g., have different or random z-direction rotational angles). This is because the direction of use of such an abrasive article is variable. Therefore, randomly orienting shaped abrasive particles can help to expose cutting faces of suitable amount of shaped abrasive particles to workpiece regardless of the specific direction of use of the random orbital sander or vibratory sander.

Shaped abrasive particles such as those described herein can account for 100 wt % of the abrasive particles in any abrasive article. Alternatively, shaped abrasive particles can be part of a blend of abrasive particles distributed on backing. If present as part of a blend, shaped abrasive particles may be in a range of from about 5 wt % to about 95 wt % of the blend, about 10 wt % to about 80 wt %, about 30 wt % to about 50 wt %, or less than, equal to, or greater than about, 5 wt %, 10, 15, 20, 25, 30, 35, 40, 45, 50, 55, 60, 65, 70, 75, 80, 85, 90, or about 95 wt %, of the blend. In the blend, the balance of the abrasive particles may include conventional crushed abrasive particles. Crushed abrasive particles are generally formed through a mechanical crushing operation and have no replicated shape. The balance of the abrasive particles can also include other shaped abrasive particles, that may for example, include an equilateral triangular shape (e.g., a flat triangular shaped abrasive particle or a tetrahedral shaped abrasive particle in which each major face of the tetrahedron is an equilateral triangle).

FIGS. 4A and 4B show embodiments in which an abrasive article is an abrasive belt or an abrasive sheet adapted for linear movement. In other embodiments, however, the abrasive article can be an abrasive disc that is adapted for rotational movement. The tangential rotational direction of use for an abrasive disc can be determined with a line tangent to an outer perimeter of the abrasive disc.

According to various embodiments, a cutting speed of the abrasive article can be at least about 100 m/min, at least about 110 m/min, at least about 120 m/min, at least about 130 m/min, at least about 140 m/min, at least about 150 m/min, at least about 160 m/min at least about 170 m/min, at least about 180 m/min, at least about 190 m/min, at least about 200 m/min, at least about 300 m/min, at least about 400 m/min, at least about 500 m/min, at least about 1000 m/min, at least about 1500 m/min, at least about 2000 m/min, at least about 2500 m/min, at least about 3000 m/min, or at least about 4000 m/min.

Abrasive articles according to the present disclosure may be used by hand and/or used in combination with a machine. At least one of the abrasive article and the workpiece is moved relative to the other when abrading. Abrading may be conducted under wet or dry conditions. Exemplary liquids for wet abrading include water, water containing conventional rust inhibiting compounds, lubricant, oil, soap, and cutting fluid. The liquid may also contain defoamers, degreasers, for example.

### Additional Embodiments

The following exemplary embodiments are provided, the numbering of which is not to be construed as designating levels of importance:

Embodiment 1 is a shaped abrasive particle. The shaped abrasive particle has a first and second surface. The first and second surfaces are substantially parallel to each other and separated by a thickness. Each of the first and second surfaces have a surface profile, which includes a plurality of corners and a plurality of edges connecting the plurality of corners. The shaped abrasive particle also includes a recess included wholly within one of the plurality of edges. The recess is a concave void extending into the surface profile. The shaped abrasive particle also includes a magnetically responsive coating. The magnetically responsive coating causes the shaped abrasive particle to be responsive to a magnetic field. The shaped abrasive particle, when exposed to the magnetic field, experiences a net torque that causes the shaped abrasive particle to orient with respect to the magnetic field such that each of the first and second surfaces are substantially perpendicular to a backing

Embodiment 2 includes the features of embodiment 1, however an edge substantially perpendicular to the backing includes a cutting face of the shaped abrasive particle. The cutting face has a first edge configured to couple to the backing and a second edge opposite the first edge. The second edge is a cutting edge configured to engage a workpiece.

Embodiment 3 includes the features of either embodiment 1 or 2, however an approximate first derivative of a normalized cross sectional area with respect to a normalized height has at least one value which is greater than −0.5 or smaller than −1.5. An approximate second derivative of the normalized cross section with respect to the normalized height has at least one value greater than 0 and at least one value less than 0.

Embodiment 4 includes the features of any of embodiments 1-3, however the particle has exactly 5 outside corners.

Embodiment 5 includes the features of embodiment 4, however a third edge between two of the outside corners has curvature.

Embodiment 6 includes the features of any of embodiments 2-5, however a cross-sectional area of the particle increases non-linearly along a height of the particle. The height includes a distance from the first edge to the second edge.

Embodiment 7 includes the features of embodiment 6, however for at least a first portion of the height of the particle, the cross-sectional area decreases. For at least a second portion of the height of the particle, the cross-sectional area increases along the height from the first edge to the second edge.

Embodiment 8 includes the features of any of embodiments 1-7, however the particle has exactly 6 outside corners.

Embodiment 9 includes the features of any of embodiments 2-8, however the cutting face has an edge length and a thickness. An aspect ratio of the edge length to the thickness is at least 2.

Embodiment 10 includes the features of embodiment 9, however the aspect ratio of height to the thickness is less than about 10.

Embodiment 11 includes the features of any of embodiments 1-10, however the magnetic field is at least 100 gauss.

Embodiment 12 includes the features of any of embodiments 1-11, however the magnetic field is at least 1000 gauss.

Embodiment 13 includes the features of any of embodiments 1-12, however the recess is greater than 10% of the area of the first surface.

Embodiment 14 is a method of using an abrasive article. The method includes contacting the abrasive article to a workpiece. The abrasive article includes a backing and a plurality of magnetically responsive particles fixed to the backing. Each of the plurality of magnetic particles are fixed to the backing along a base edge such that the base edge of some of the particles are substantially parallel to each other and such that a cutting face of some of the plurality of magnetic particles are parallel to each other. The method also includes moving the abrasive article with respect to the workpiece such that a surface of the workpiece is abraded, wearing abrading the workpiece causes the plurality of magnetically responsive particles to wear down. Wearing down includes a height of the particles to decrease with use. For at least a portion of the height, a substantially constant cross-sectional area is maintained relatively unchanged from an initial cross-sectional area of the portion of the height during wear down.

Embodiment 15 includes the features of embodiment 14, however the substantially constant cross-sectional area has a minimum cross sectional area and a maximum cross-sectional area. The maximum cross sectional area is less than 150% of the minimum cross-sectional area.

Embodiment 16 includes the features of embodiments 14 or 15, however the cutting face of each of the plurality of magnetic particles has a cutting edge that contacts the workpiece during abrasion.

Embodiment 17 includes the features of any of embodiments 14-16, however the plurality of magnetically responsive particles have a rake angle. The rake angle is between −29° and 170°.

Embodiment 18 includes the features of any of embodiments 14-17, however the plurality of magnetically responsive particles have exactly five corners.

Embodiment 19 includes the features of any of embodiments 14-18, however the plurality of magnetically responsive particles have exactly six corners.

Embodiment 20 includes the features of any of embodiments 14-19, however each of the plurality of magnetically responsive particles has a cutting portion and a base portion. The cutting portion has an aspect ratio between 2 and 10. The base portion has an aspect ratio between 1.5 and 10.

Embodiment 21 includes the features of any of embodiments 14-20, however each of the plurality of magnetically responsive particles is symmetrical about a line of symmetry extending through a corner connecting a cutting edge of the cutting face and the base edge.

Embodiment 22 includes the features of any of embodiments 14-21, however the base edge of a portion of the plurality particles are substantially parallel to each other and such that a cutting face of a portion of the plurality of magnetic particles are parallel to each other. The portion is a percentage greater than would have occurred randomly.

Embodiment 23 includes the features of any of embodiments 14-22, however the base edge of a majority of the plurality particles are substantially parallel to each other and such that a cutting face of the majority of the plurality of magnetic particles are parallel to each other.

Embodiment 24 is a method of making a shaped abrasive particle. The method includes providing a tool with a mold cavity having a tool geometry at the tool surface. The tool geometry includes a substantially polygonal shape including a hypothetical polygon with a defect extending into an interior of the hypothetical polygon. The method also includes filling the mold cavity with an abrasive particle precursor mixture. The method also includes drying the abrasive particle precursor mixture within the mold cavity. The method also includes removing an abrasive particle precursor from the mold cavity. The abrasive particle precursor has a shape that corresponds to a negative image of the mold cavity. The shape includes a face having a particle geometry corresponding to the tool geometry, and a thickness corresponding to a depth of the mold cavity. The method also includes firing the abrasive particle precursor to obtain the shaped abrasive particle. The shaped abrasive particle is responsive to a magnetic field such that, when experiencing the magnetic field, the shaped abrasive particle transitions from a lay-flat position to a standing position. In the lay-flat position the shaped abrasive particle rests on the face and. In the standing position the abrasive particle rests on the thickness.

Embodiment 25 includes the features of embodiment 24, however the hypothetical polygon includes a triangle.

Embodiment 26 includes the features of embodiments 24 or 25, however filling the mold cavity includes leveling the abrasive particle precursor material such that a sharp edge is created on the shaped abrasive particle at an interface between the mold cavity and the tool surface.

Embodiment 27 includes the features of any of embodiments 24-26, however the abrasive particle precursor includes a ceramic material.

Embodiment 28 includes the features of any of embodiments 24-27, however the abrasive particle precursor includes alpha alumina.

Embodiment 29 is a method of making an abrasive article. The method includes providing a backing. The method also includes providing a plurality of magnetically responsive abrasive particles, each of the magnetically responsive abrasive particles including a cutting portion and a base portion. The cutting portion includes a cutting surface, the base portion includes a base surface. An aspect ratio of the base portion, including a ratio of a base edge length to an average base width is between 1.5 and 10. The method also includes providing a magnetic field that causes a majority of the abrasive particles to align such that the cutting surfaces of the particles are parallel to each other and the base surfaces are parallel to each other, and such that the cutting surfaces do not substantially contact the backing. The method also includes fixing the aligned abrasive particles to the backing.

Embodiment 30 includes the features of embodiment 29, however each of the magnetically responsive abrasive particles experiences a net magnetic torque in the combined magnetic and gravitational fields, causing each of the magnetically responsive abrasive particles to orient in a stable position resting on the base portion.

Embodiment 31 includes the features of either embodiment 29 or 30, however each of the magnetically responsive abrasive particles is a shaped abrasive particle including a surface with a theoretical polygonal perimeter. An edge of the theoretical polygonal perimeter has a concave indentation.

Embodiment 32 includes the features of embodiment 31, however the concave indentation extends between a first point and a second point. The first point and the second point are not in contact with a cutting edge or a base edge.

Embodiment 33 includes the features of embodiment 32, however the theoretical polygonal perimeter includes a triangle. A theoretical hypotenuse includes the concave indentation.

Embodiment 34 includes the features of embodiment 33, however the triangle includes a right triangle, an isosceles triangle, an equilateral triangle, an obtuse triangle, or an acute triangle.

Embodiment 35 includes the features of any of embodiments 31-34, however the theoretical polygonal perimeter includes a quadrilateral.

Embodiment 36 includes the features of embodiment 35, however the first point is on a third edge of the quadrilateral and the second point is on a fourth edge of the quadrilateral.

Embodiment 37 includes the features of any of embodiments 31-36, however each of the magnetically responsive abrasive particles is symmetrical about a line of symmetry that extends through the concave indentation and a corner formed by the cutting surface and the base surface.

Embodiment 38 includes the features of any of embodiments 29-37, however fixing includes applying a make coat precursor layer to the backing and curing the make coat precursor layer.

Embodiment 39 includes the features of embodiment 38, however the make coat precursor is applied before the abrasive particles are aligned, such that the abrasive particles embed within the make coat precursor layer.

Embodiment 40 includes the features of embodiment 38, however the make coat precursor is applied after the abrasive particles are aligned, such that the base face of the aligned abrasive particles directly contacts the backing.

Embodiment 41 includes the features of any of embodiments 29-40, however the magnetically responsive particles are similarly sized with respect to one another.

Embodiment 42 includes the features of any of embodiments 29-41, however the abrasive article is an abrasive belt.

Embodiment 43 includes the features of any of embodiments 29-41, however the abrasive article is an abrasive disc.

Embodiment 44 includes the features of any of embodiments 29-43, however the magnetically responsive particles are ceramic particles.

Embodiment 45 includes the features of any of embodiments 29-44, however an aspect ratio of the cutting portion, including a ratio of a cutting edge length to a particle thickness is between 2 and 10.

Embodiment 46 includes the features of any of embodiments 29-45, however the cutting surface is at an angle with respect to the backing. The angle is between 300 and 1690.

Embodiment 47 includes the features of any of embodiments 29-46, however the cutting surface has a cutting edge configured to engage a workpiece.

Embodiment 48 is a magnetically responsive shaped abrasive particle. The abrasive particle includes a base portion having a base height and a base thickness. The base height is perpendicular to a base thickness. The abrasive particle also includes a cutting portion having a cutting portion height and an average cutting portion thickness. The cutting portion height is perpendicular to the average cutting portion thickness. The cutting portion height is greater than the average cutting portion thickness. The cutting portion has a substantially constant cross-sectional area along at least a portion of the cutting portion height. In response to a magnetic field, the base portion experiences a base magnetic moment, the cutting portion experiences a cutting portion magnetic moment, and the magnetically responsive shaped abrasive particle experiences a net magnetic torque that orients the magnetically responsive shaped abrasive particle such that it rests on the base portion. The base portion and the cutting portion include a monolithic particle free of a binder material.

Embodiment 49 includes the features of embodiment 48, however an aspect ratio of the base portion is between 1.5 and 10.

Embodiment 50 includes the features of either embodiment 48 or 49, however an aspect ratio of the cutting portion is between 2 and 10.

Embodiment 51 includes the features of any of embodiments 48-50, however the base portion has a base width. The base width is less than the base thickness.

Embodiment 52 includes the features of any of embodiments 48-51, however the base portion has a base width. The base width is about equal to the base thickness.

Embodiment 53 includes the features of any of embodiments 48-52, however the magnetically responsive particles are ceramic particles.

Embodiment 54 includes the features of embodiment 53, however the ceramic particles include alpha alumina.

Embodiment 55 includes the features of embodiment 53, however the magnetically responsive particles include a ceramic layer and a magnetic material layer.

Embodiment 56 is a magnetically responsive abrasive particle with a first and second side separated by a thickness. A first shape of the first side is substantially similar to a second shape of the second side. The particle also has a magnetic coating present on the first side. The first shape includes a first edge and a second edge. The first edge is a cutting edge and the second edge is a base edge. A height of the magnetically responsive abrasive particle is a longest distance, measured perpendicularly from the base edge, from the base edge to a tip of the cutting edge. An approximate first derivative of a normalize cross sectional area with respect to the height is found to have at least one value greater than −0.5 or smaller than −1.5. The approximate second derivative of the normalized cross-sectional area with respect to the height is found to have at least one value greater than 0 and at least one value less than 0.

Embodiment 57 includes the features of embodiment 56, however the first shape has five corners.

Embodiment 58 includes the features of embodiment 56, however the first shape has six corners.

Embodiment 59 includes the features of any of embodiments 56-58, however a third edge, connected to both the cutting edge and the base edge, has a recess. The recess does not extend to either a first corner connecting the third edge and the cutting edge or a second corner connecting the third edge and the base edge.

Embodiment 60 includes the features of any of embodiments 56-59, however the magnetic coating present on substantially all surfaces of the magnetically responsive particle.

Embodiment 61 includes the features of any of embodiments 56-60, however the cutting edge and the base edge form a 90° angle such that the height is a length of cutting edge.

Embodiment 62 includes the features of any of embodiments 56-61, however the cutting edge and the base edge form an acute angle.

Embodiment 63 includes the features of any of embodiments 56-62, however the cutting edge and the base edge form an obtuse angle.

Embodiment 64 is a magnetically responsive abrasive particle with a first particle portion and a second particle portion. The first and second particle portions are connected such that a first particle portion first end connects to a second particle portion first end. The abrasive particle includes a cutting edge located on a first particle portion second end. An aspect ratio of the first particle portion is between about 1.5 and about 20. The aspect ratio is a length of the first particle portion divided by the thickness of the first particle portion. A magnetic coating on at least one side of the magnetically responsive particle. The magnetic coating causes the magnetic particle, when exposed to a magnetic field, to align such that it rests on the second particle portion and the cutting edge faces away from the second particle portion.

Embodiment 65 includes the features of embodiment 64, however a second aspect ratio of the second particle portion is between 1.5 and 10. The second aspect ratio is a second length of the second particle portion divided by a width of the second particle portion.

Embodiment 66 includes the features of any of embodiments 64-65, however the first particle portion first end connects to second particle first end such that an acute angle is formed between first particle portion and second particle portion.

Embodiment 67 includes the features of any of embodiments 64-66, however the first particle portion first end connects to second particle first end such that an obtuse angle is formed between first particle portion and second particle portion.

Embodiment 68 includes the features of any of embodiments 64-67, however The first particle portion first end connects to second particle first end such that an 90° angle is formed between first particle portion and second particle portion.

Embodiment 69 includes the features of any of embodiments 64-68, however a cross-section of the first particle portion has a polygonal shape.

Embodiment 70 includes the features of embodiment 69, however the polygonal shape is a triangle, a quadrilateral, a trapezoid, a rectangle, a square, or a kite.

Embodiment 71 includes the features of any of embodiments 64-70, however the thickness is between 10% and 1000% of the length.

Embodiment 72 includes the features of any of embodiments 64-71, however the thickness of the first particle portion is substantially similar to a second thickness of the second particle portion.

Embodiment 73 includes the features of any of embodiments 64-72, however the cross-sectional area of the first particle portion is substantially constant for a portion of the length.

Embodiment 74 includes the features of embodiment 73, however for the portion of the length, a maximum cross-sectional area is no more than 150% of a minimum cross-sectional area.

### EXAMPLES

Various embodiments of the present disclosure can be better understood by reference to the following Examples which are offered by way of illustration. The present disclosure is not limited to the Examples given herein.

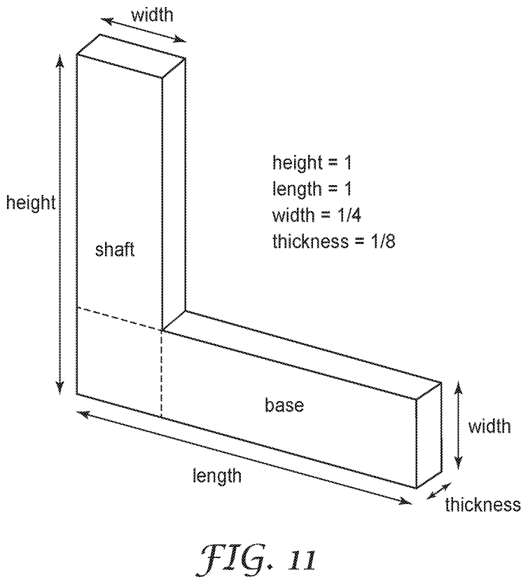

FIG. 11-32 illustrate particles described in the Examples.

### Example 1

Example 1 provides a conceptual understanding into why some magnetic abrasive particle shapes (i.e., those shown in FIGS. 6A-1 and 6B-1) tend to stand upright on a thickness of the particle when exposed to a vertical magnetic field, and other magnetic abrasive particle shapes (i.e., that shown in FIG. 6C-1) tend to lay on a face when exposed to the same magnetic environment.

To enable a conceptual understanding (without the need to rely on computer modeling), the magnetic particles considered in this example will have simple L-shaped profile as shown in FIGS. 11, 12 and 13. This L-shaped particle will be considered to consist of two components, the base and the shaft, as shown in FIG. 11. When exposed to a vertical magnetic field this L-shaped particle will experience a net magnetic torque, with magnetic torque contributions from the base and shaft. In this example, the magnetic torque contributions of the shaft and base are first considered independently, and then these torque contributions are considered together to develop a net torque conclusion.

### Magnetic Framework

In the following analyses, the magnetic environment consists of a vertical magnetic field, and the longest dimension of a magnetic body will tend to rotate to align with this magnetic field. The particle (and its independently considered base and shaft) will be considered constrained to rotation about an axis that is parallel to the length of the base (i.e., the particle is only allowed to stand on its face or thickness of the base).

### Conceptual Analysis of Particle A

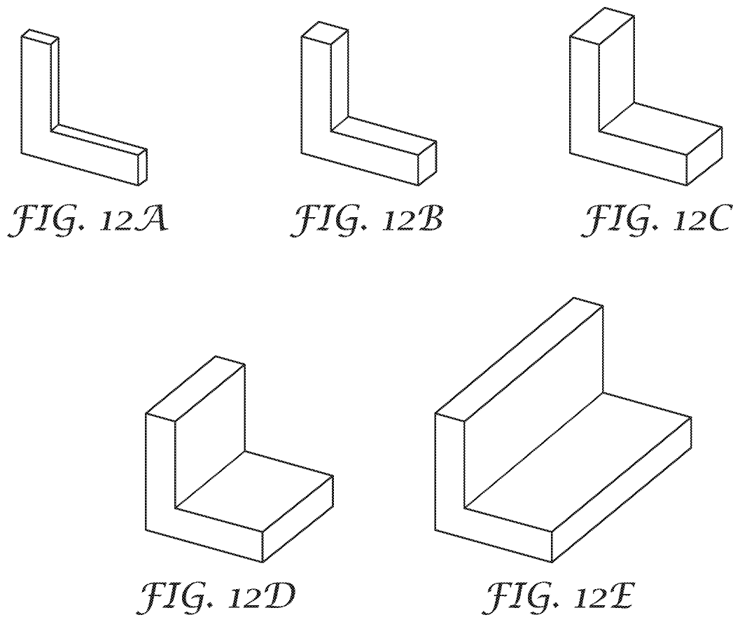

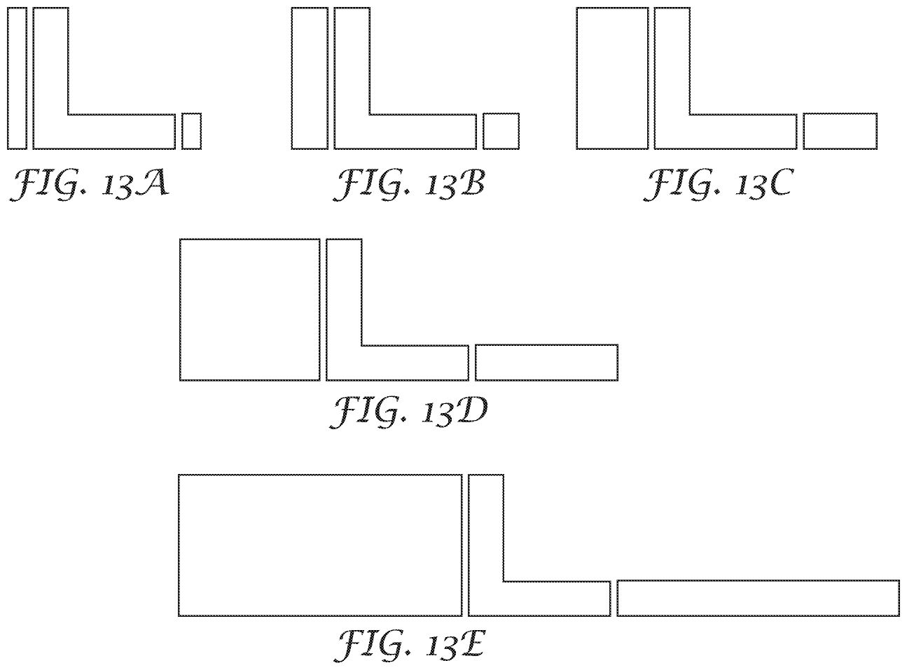

Particle A is shown standing upright on its thickness in FIGS. 11 and 12. FIG. 13 shows the cross-section of the shaft and base from a perspective along the length, about which the particle is constrained to rotate. It can be seen in FIG. 13 for Particle A that the longest dimension of the cross section for the shaft is along the height of the cross-section. This will result in a magnetic torque that tends to rotate the shaft height to align with the vertical magnetic field. It can be seen in FIG. 13 for Particle A that the longest dimension of the cross section for the base is along the width (which is parallel to the height of the shaft) of the cross-section. This will result in a magnetic torque that tends to rotate the base width to align with the vertical magnetic field. The magnetic torque of the shaft and the magnetic torque of the base both tend to rotate the particle to an upright position, resulting in a net magnetic torque that tends to orient the particle into an upright position.

### Conceptual Analysis of Particle B

Particle B is shown standing upright on its thickness in FIG. 12. FIG. 13 shows the cross-section of the shaft and base from a perspective along the length, about which the particle is constrained to rotate. It can be seen in FIG. 13 for Particle B that the longest dimension of the cross section for the shaft is along the height of the cross-section. This will result in a magnetic torque that tends to rotate the shaft height to align with the vertical magnetic field. It can be seen in FIG. 13 for Particle B that the cross section of the base is approximately square, resulting in no magnetic torque acting on the base of Particle B. The magnetic torque of the shaft tends to rotate the particle to an upright position, but the base produces no magnetic torque, resulting in a net magnetic torque that tends to orient the particle into an upright position.

### Conceptual Analysis of Particle C

Particle C is shown standing upright on its thickness in FIG. 12. FIG. 13 shows the cross-section of the shaft and base from a perspective along the length, about which the particle is constrained to rotate. It can be seen in FIG. 13 for Particle C that the longest dimension of the cross section for the shaft is along the height of the cross-section. This will result in a magnetic torque that tends to rotate the shaft height to align with the vertical magnetic field. It can be seen in FIG. 13 for Particle C that the longest dimension of the cross section for the base is along the thickness of the cross-section. This will result in a magnetic torque that tends to rotate the base thickness to align with the vertical magnetic field, orienting the particle onto its face. The magnetic torque of the shaft tends to rotate the particle to an upright position, while the magnetic torque of the base tends to rotate the particle in the opposite direction with a tendency to lay it on its face. A more rigorous mathematical analysis is needed to determine if the resulting net magnetic torque will be dominated by the shaft or the base; a simple conceptual analysis is inadequate to determine the net magnetic torque for Particle C.

### Conceptual Analysis of Particle D

Particle D is shown standing upright on its thickness in FIG. 12. FIG. 13 shows the cross-section of the shaft and base from a perspective along the length, about which the particle is constrained to rotate. It can be seen in FIG. 13 for Particle D that the cross section of the shaft is approximately square, resulting in no magnetic torque acting on the shaft of Particle D. It can be seen in FIG. 13 for Particle D that the longest dimension of the cross section for the base is along the thickness of the cross-section. This will result in a magnetic torque that tends to rotate the base thickness to align with the vertical magnetic field, orienting the particle on its face. The magnetic torque of the base tends to rotate the particle onto its face, but the shaft produces no magnetic torque, resulting in a net magnetic torque that tends to rotate the particle onto its face.

### Conceptual Analysis of Particle E

Particle E is shown standing upright on its thickness in FIG. 12. FIG. 13 shows the cross-section of the shaft and base from a perspective along the length, about which the particle is constrained to rotate. It can be seen in FIG. 13 for Particle E that the longest dimension of the cross section for the shaft is along the thickness of the cross-section. This will result in a magnetic torque that tends to rotate the shaft thickness to align with the vertical magnetic field, orienting the particle onto its face. It can be seen in FIG. 13 for Particle E that the longest dimension of the cross section for the base is along the thickness of the cross-section. This will result in a magnetic torque that tends to rotate the base thickness to align with the vertical magnetic field, orienting the particle onto its face. The magnetic torque of the shaft and the magnetic torque of the base both tend to rotate the particle onto its face, resulting in a net magnetic torque that tends to orient the particle onto its face.

### Example 1 Summary

A conceptual analysis is able to determine that the dimensions of Particle A and Particle B will result in a net magnetic force that will tend to stand these particles upright on the thickness of the particle base, and that the dimensions of Particle D and Particle E will result in a net magnetic force that will tend to lay these particles on a face of the particle. A conceptual analysis is inadequate to determine if the dimensions of Particle C will result in a net magnetic torque that will tend to rotate the particle upright or if the net magnetic torque will tend to rotate the particle to lay on a face.

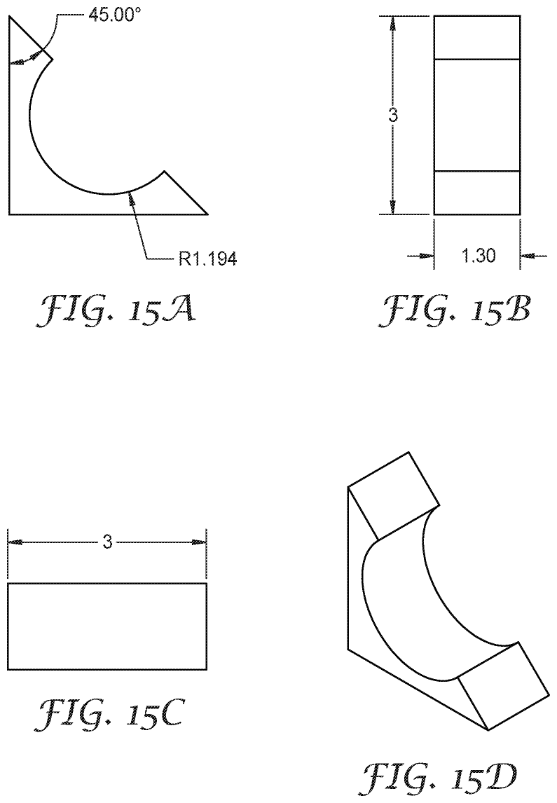

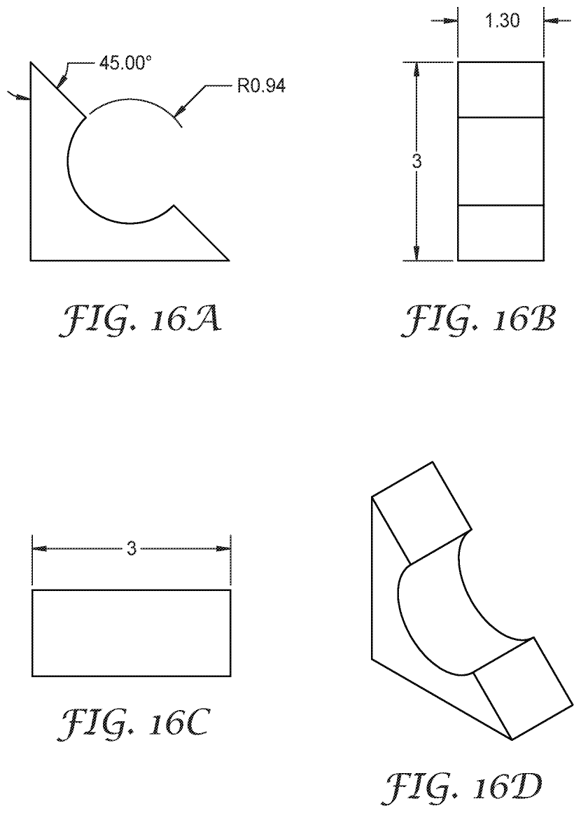

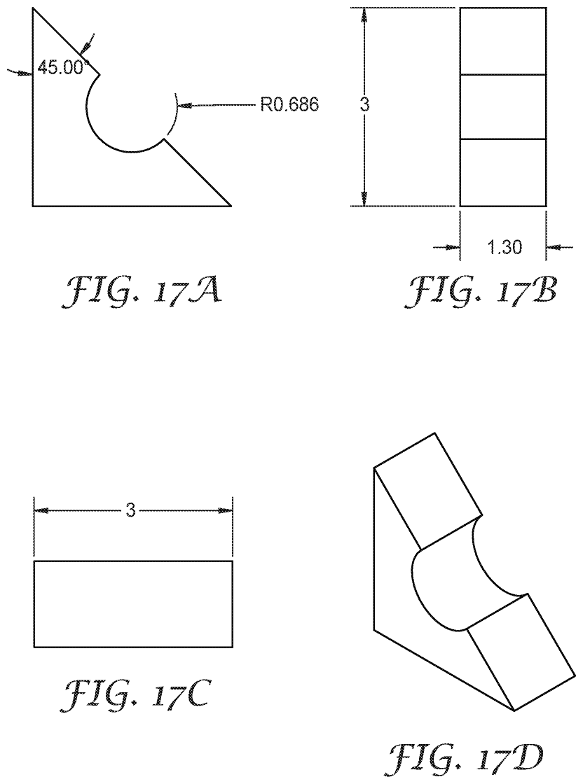

TABLE 2

| ABBREVIATION | DESCRIPTION |
|---|---|
| AP1 | Shaped abrasive particles were |
| | prepared by 3D printing particles |
| | with a stereolithography 3D printer |
| | (ProJet 7000HD, 3D |
| | Systems, Littleton, CO) machine |
| | using Accura 25 resin (3D |
| | Systems, Littleton, CO). The particles |
| | were printed to the shape |
| | shown in FIGS. 17A−D. |
| | Measurements are in millimeters. |
| AP2 | Shaped abrasive particles were |
| | prepared by 3D printing particles |
| | with a stereolithography 3D |
| | printer (ProJet 7000HD, 3D |
| | Systems, Littleton, CO) machine |
| | using Accura 25 resin (3D |
| | Systems, Littleton, CO). The particles |
| | were printed to the shape |
| | shown in FIGS. 16A−D. |
| | Measurements are in millimeters. |
| AP3 | Shaped abrasive particles were prepared |
| | by 3D printing particles |
| | with a stereolithography 3D printer |
| | (ProJet 7000HD, 3D |
| | Systems, Littleton, CO) machine |
| | using Accura 25 resin (3D |
| | Systems, Littleton, CO). The |
| | particles were printed to the shape |
| | shown in FIGS. 15A−D. |
| | Measurements are in millimeters. |

### Preparation of Magnetizable Abrasive Particles (MAP1)

AP1 was coated with 304 stainless steel using physical vapor deposition with magnetron sputtering. 304 Stainless steel sputter target, described by Barbee et al. in Thin Solid Films, 1979, vol. 63, pp. 143-150, deposited as the magnetic ferritic body centered cubic form. The apparatus used for the preparation of 304 stainless steel film coated abrasive particles (i.e., magnetizable abrasive particles) was disclosed in U.S. Pat. No. 8,698,394 (McCutcheon et al.). The physical vapor deposition was carried out for 4 hours at 1.0 kilowatt at an argon sputtering gas pressure of 10 millitorr (1.33 pascal) onto 75 grams of AP1. The coating thickness is approximately 1 micron.

### Preparation of Magnetizable Abrasive Particles (MAP2)

AP2 was coated with 304 stainless steel using physical vapor deposition with magnetron sputtering. 304 Stainless steel sputter target, described by Barbee et al. in Thin Solid Films, 1979, vol. 63, pp. 143-150, deposited as the magnetic ferritic body centered cubic form. The apparatus used for the preparation of 304 stainless steel film coated abrasive particles (i.e., magnetizable abrasive particles) was disclosed in U.S. Pat. No. 8,698,394 (McCutcheon et al.). The physical vapor deposition was carried out for 4 hours at 1.0 kilowatt at an argon sputtering gas pressure of 10 millitorr (1.33 pascal) onto 75 grams of AP2. The coating thickness is approximately 1 micron.

### Preparation of Magnetizable Abrasive Particles (MAP3)

AP3 was coated with 304 stainless steel using physical vapor deposition with magnetron sputtering. 304 Stainless steel sputter target, described by Barbee et al. in Thin Solid Films, 1979, vol. 63, pp. 143-150, deposited as the magnetic ferritic body centered cubic form. The apparatus used for the preparation of 304 stainless steel film coated abrasive particles (i.e., magnetizable abrasive particles) was disclosed in U.S. Pat. No. 8,698,394 (McCutcheon et al.). The physical vapor deposition was carried out for 4 hours at 1.0 kilowatt at an argon sputtering gas pressure of 10 millitorr (1.33 pascal) onto 75 grams of AP3. The coating thickness is approximately 1 micron.

### Assembly of Magnet Apparatus (MAG1)

Upper magnet assembly UM1 was formed from 3 identical rectangular magnets, each being 4″ wide by 3″ deep by 2″ thick, magnetized through the thickness of grade N52 magnetic material (from SM Magnetics, Pelham, Ala.). These 3 magnets were arranged to form a magnet assembly 12″ wide by 3″ deep by 2″ thick, with the magnetic pole of each magnet oriented in the same direction, with like poles in the same plane. This magnet arrangement was adhered to a plate of 1018 steel (14″ wide by 5″ deep by 3″ thick) with epoxy resin (DP460, 3M Company, St. Paul, Minn.) and covered with a 0.1875″ thick sheet of 304 stainless steel.

Lower magnet assembly LM1 was formed in the identical manner as UM1, with the exception being that the opposite poles were facing away from the steel plate.

Magnet apparatus MAG1 was formed by combining UM1 and LM1. UM1 and LM1 were arranged with like poles facing the same direction and a gap of 4.5 inches between the lower surface of UM1 and the upper surface of LM1. LM1 was then shifted upstream so the centerline of UM1 and LM1 was 3 inches apart.

### Example 2

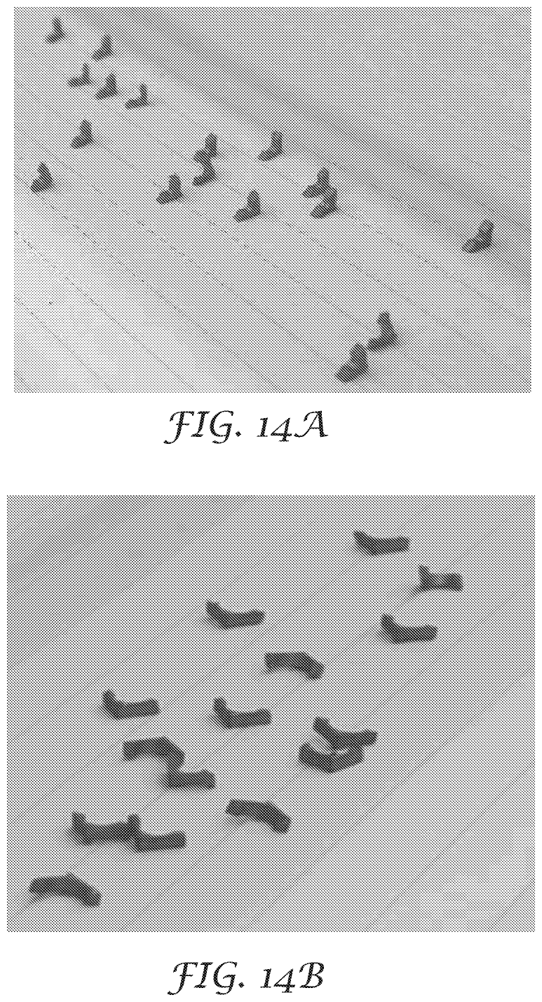

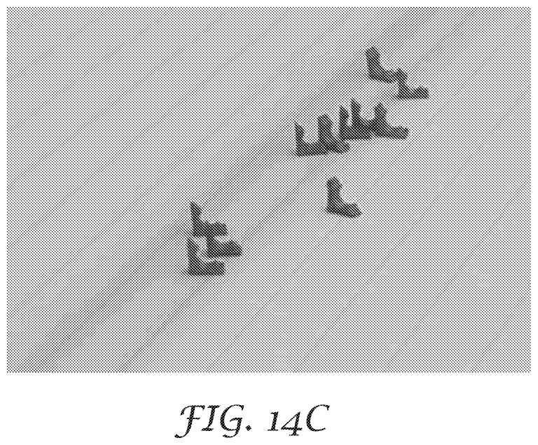

A length of paper was placed into MA1. Abrasive particles MAP1 were dispensed into MAG1 above the top surface of LM1 via a sloped dispensing ramp. Particles were all oriented upright with substantial parallel alignment, as shown in the photograph in FIG. 14A.

### Example 3

A length of paper was placed into MA1. Abrasive particles MAP2 were dispensed into MAG1 above the top surface of LM1 via a sloped dispensing ramp. Particles were all oriented upright with substantial parallel alignment, as shown in the photograph in FIG. 14A.

### Comparative Example A

A length of paper was placed into MA1. Abrasive particles MAP3 were dispensed into MAG1 above the top surface of LM1 via a sloped dispensing ramp. Particles were all lying down on their sides, as shown in the photograph in FIG. 14B.

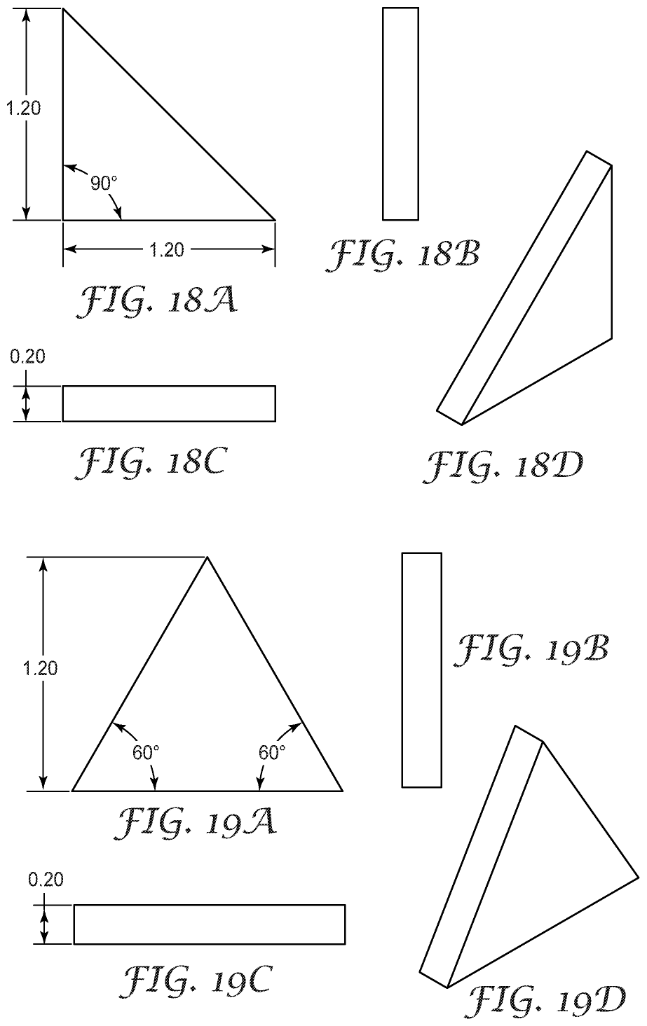

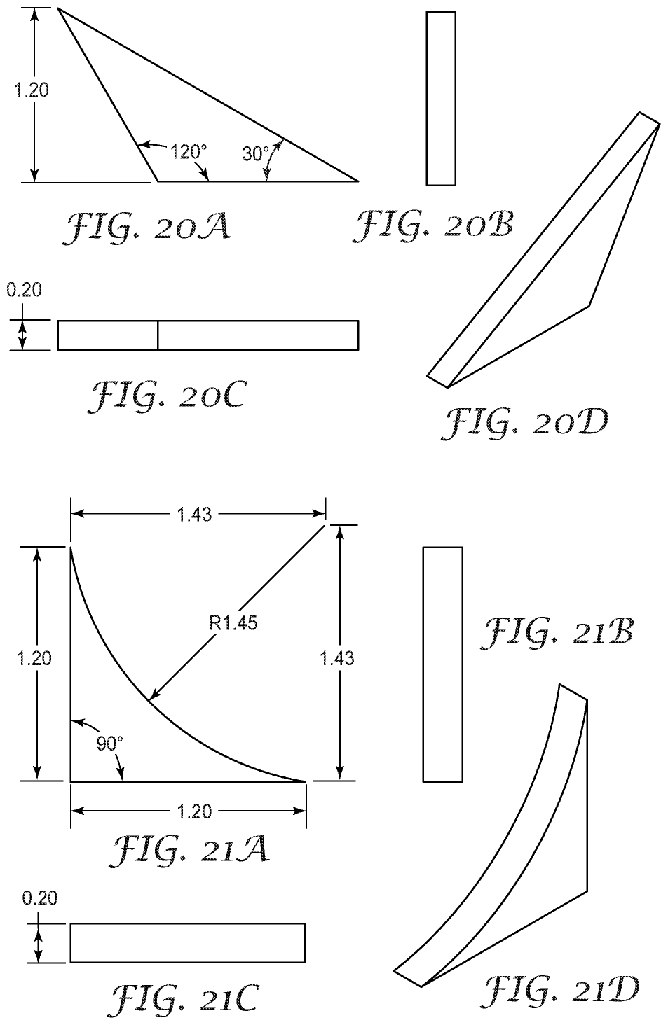

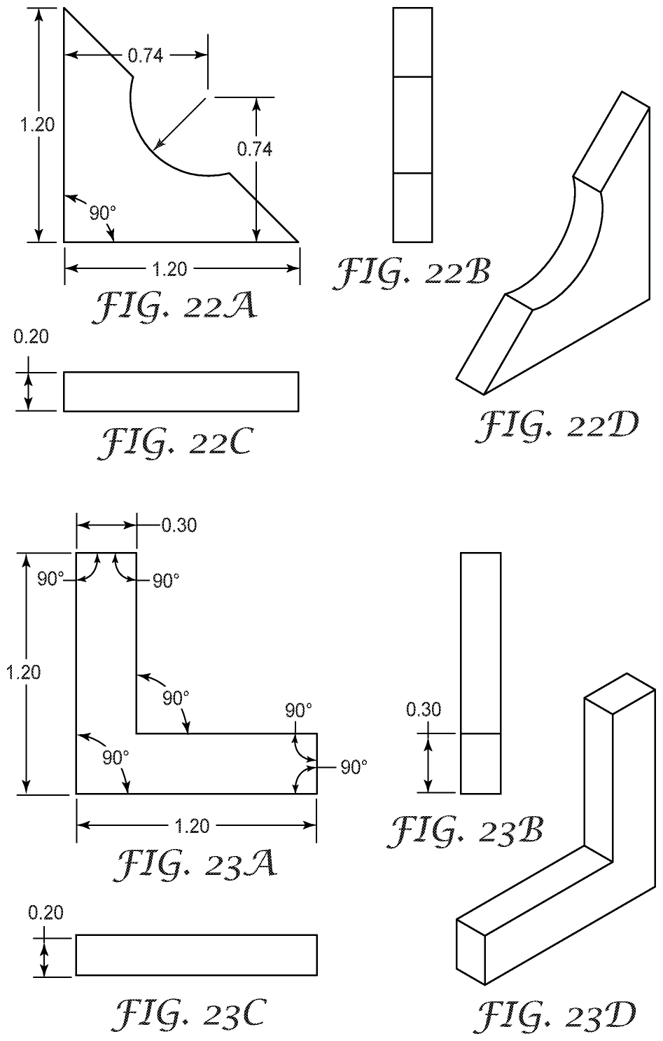

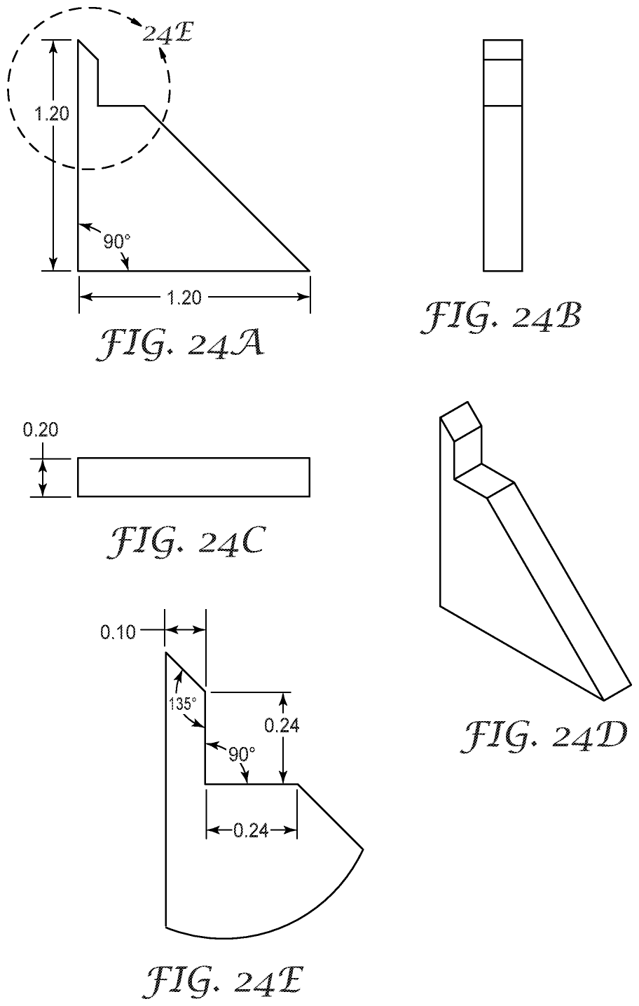

TABLE 3

| ABBREVIATION | DESCRIPTION |
|---|---|
| GS1 | Shaped abrasive particle geometry CAD model prepared with Solidworks |
| | 2017 (Dassault Systemes). The particle linear dimensions are in |
| | millimeters and angles in degrees with dimensions shown in FIGS. 18A− |
| | D. |
| GS2 | Shaped abrasive particle geometry CAD model prepared with Solidworks |
| | 2017 (Dassault Systemes). The particle linear dimensions are in |
| | millimeters and angles in degrees with dimensions shown in FIGS. 19A− |
| | D. |
| GS3 | Shaped abrasive particle geometry CAD model prepared with Solidworks |
| | 2017 (Dassault Systemes). The particle linear dimensions are in |
| | millimeters and angles in degrees with dimensions shown in FIGS. 20A− |
| | D. |
| GS4 | Shaped abrasive particle geometry CAD model prepared with Solidworks |
| | 2017 (Dassault Systemes). The particle linear dimensions are in |
| | millimeters and angles in degrees with dimensions shown in FIGS. 21A− |
| | D. |
| GS5 | Shaped abrasive particle geometry CAD model prepared with Solidworks |
| | 2017 (Dassault Systemes). The particle linear dimensions are in |
| | millimeters and angles in degrees with dimensions shown in FIGS. 22A− |
| | D. |
| GS6 | Shaped abrasive particle geometry CAD model prepared with Solidworks |
| | 2017 (Dassault Systemes). The particle linear dimensions are in |
| | millimeters and angles in degrees with dimensions shown in FIGS. 23 A− |
| | D. |
| GS7 | Shaped abrasive particle geometry CAD model prepared with Solidworks |
| | 2017 (Dassault Systemes). The particle linear dimensions are in |
| | millimeters and angles in degrees with dimensions shown in FIGS. 24A− |
| | D. |

Examples 4-11 describe a different way to characterize desired criteria for a magnetically coated abrasive particle. Described below are methods and results of cross-sectional area calculations and approximated first and second derivative calculations. To avoid the noise introduced by surface roughness and variability in measurement techniques, a sampling method using a set number of evenly spaced planes and approximated first and second derivatives is used. This is key to meeting the criterion set out in the claims where a higher sampling frequency or curve fitted data may significantly alter the shape of the first and second derivative calculations. As used herein, cross-sectional areas, approximate first derivatives and approximate second derivatives refer to results obtained from using the methods described below.

### Cross Sectional Area Calculation (CSAC)

The cross-sectional area of the geometries was determined by generating a reference line segment perpendicular to a best fit plane of the bottom surface of the particle (base plane). The reference line segment end-points are coincident with the base plane at one end and coincident with the geometry point furthest from this base plane on the other end. 11 planes were then constructed perpendicular to this line segment and spaced equally along the line segment. Plane 1 was located at the point furthest from the base plane and plane 11 was located at the base plane. The height at Plane 1 is equal to the length of the line segment. The height at Plane 11 is set at 0. Planes 2-10 were numbered in ascending order from plane 1 to plane 11 at descending heights from the height at plane 1 to the height at plane 11.

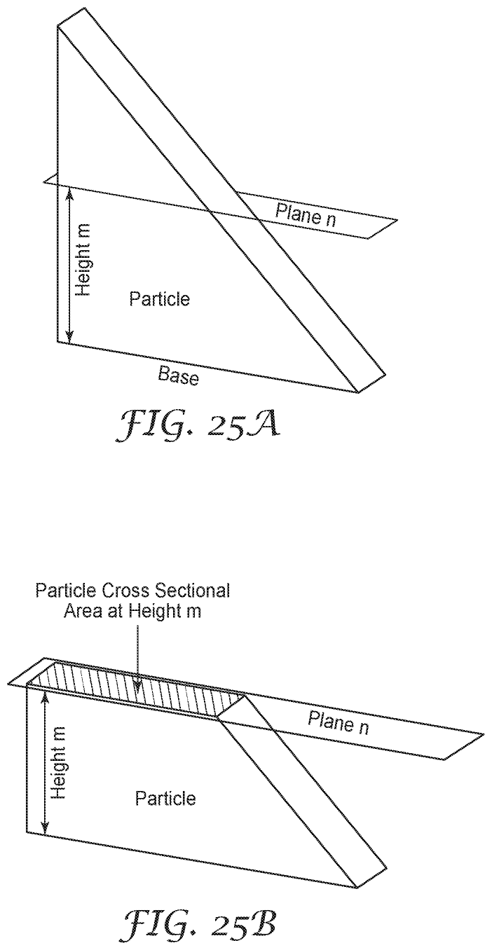

For each plane, the boundary at the intersection of the particle was determined and the area calculated. This was done using the measure function within the CAD software for the intersection as shown in FIG. 25B.

Approximate First Derivative of Normalized Cross-Sectional Area Relative to Normalized Plane Height from Base Calculation (FD)

For each plane on the geometry, the normalized cross-sectional area (NCSA) was determined by dividing each plane's cross-sectional area by the maximum cross-sectional area for the set of planes 1 through 11.

For each plane on the geometry, the normalized height from the base (NHB) was calculated by dividing each plane's height by the height of Plane 1.

The rate of change before the current plane n (RCB) from a plane n−1 was determined by applying the backward difference formula as written in Equation A.

$$R C B = \frac{N C S {A}_{Plane n} - N C S {A}_{Plane n - 1}}{N H {B}_{Plane n} - N H {B}_{Plane n - 1}} \qquad EQUATION A$$

The rate of change after the current plane n (RCA) to a plane n+1 was determined by applying the forward difference formula as written in Equation B.

$$RCA = \frac{N C S {A}_{Plane n + 1} - N C S {A}_{Plane n}}{N H {B}_{Plane n + 1} - N H {B}_{Plane n}} \qquad EQUATION B$$

The FD (Average First Derivative) was calculated as the RCA for Plane 1 and calculated as the RCB for Plane 11. For planes 2-10, the FD was calculated as the average of the RCA and RCB.

Approximate Second Derivative of FD relative to Normalized Plane Height from Base Calculation (SD)

The secondary rate of change before the current plane n (SRCB) from a plane n−1 was determined using Equation C.

$$SRCB = \frac{F {D}_{Plane n} - F {D}_{Plane n - 1}}{N H {B}_{Plane n} - N H {B}_{Plane n - 1}} \qquad EQUATION C$$

The secondary rate of change after the current plane n (SRCA) to a plane n+1 was determined using Equation D.

$$SRCA = \frac{F {D}_{Plane n + 1} - F {D}_{P lane n}}{N H {B}_{Plane n + 1} - N H {B}_{Plane n}} \qquad EQUATION D$$

The SD was calculated as the SRCA for Plane 1 and calculated as the SRCB for Plane 11. For planes 2-10, the SD was calculated as the average of the SRCA and SRCB.

### Example 4

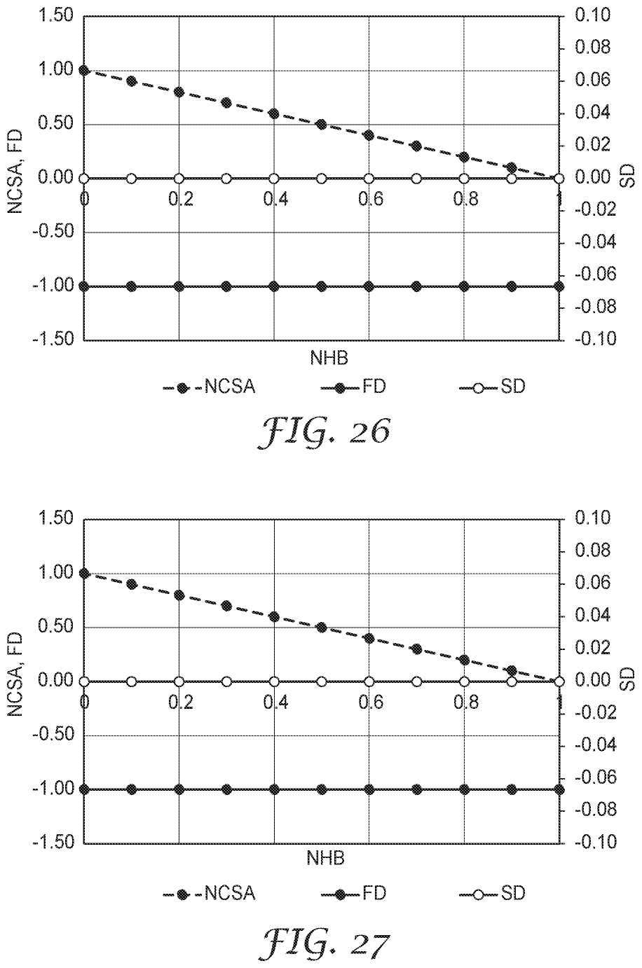

For particle geometry GS1 shown in FIGS. 18A-D, the NCSA, NSB, CSA, FD and SD were calculated in Table 4 and shown in FIG. 26. The minimum FD was −1.0 and maximum FD was −1.0, which does not meet the criterion of having a point outside the range of less than −1.5 or greater than −0.5. The maximum SD was 0.00 and the minimum SD was 0.00 which does not meet the criterion of having a value greater than 0.0 and a value less than 0.

TABLE 4

| Plane # | NHB | NCSA | FD | SD |
|---|---|---|---|---|
| 1 | 1 | 0.00 | −1.00 | 0.00 |
| 2 | 0.9 | 0.10 | −1.00 | 0.00 |
| 3 | 0.8 | 0.20 | −1.00 | 0.00 |
| 4 | 0.7 | 0.30 | −1.00 | 0.00 |
| 5 | 0.6 | 0.40 | −1.00 | 0.00 |
| 6 | 0.5 | 0.50 | −1.00 | 0.00 |
| 7 | 0.4 | 0.60 | −1.00 | 0.00 |
| 8 | 0.3 | 0.70 | −1.00 | 0.00 |
| 9 | 0.2 | 0.80 | −1.00 | 0.00 |
| 10 | 0.1 | 0.90 | −1.00 | 0.00 |
| 11 | 0 | 1.00 | −1.00 | 0.00 |

### Example 5

For particle geometry GS2 shown in FIGS. 19A-D, the NCSA, NSB, CSA, FD and SD were calculated in Table 5 and shown in FIG. 27. The minimum FD was −1.0 and maximum FD was −1.0, which does not meet the criterion of having a point outside the desired range of less than −1.5 or greater than −0.5. The maximum SD was 0.00 and the minimum SD was which does not meet the criterion with a value greater than 0.0 and a value less than 0.0.

TABLE 5

| Plane # | NHB | NCSA | FD | SD |
|---|---|---|---|---|
| 1 | 1 | 0.00 | −1.00 | 0.00 |
| 2 | 0.9 | 0.10 | −1.00 | 0.00 |
| 3 | 0.8 | 0.20 | −1.00 | 0.00 |
| 4 | 0.7 | 0.30 | −1.00 | 0.00 |
| 5 | 0.6 | 0.40 | −1.00 | 0.00 |
| 6 | 0.5 | 0.50 | −1.00 | 0.00 |
| 7 | 0.4 | 0.60 | −1.00 | 0.00 |
| 8 | 0.3 | 0.70 | −1.00 | 0.00 |
| 9 | 0.2 | 0.80 | −1.00 | 0.00 |
| 10 | 0.1 | 0.90 | −1.00 | 0.00 |
| 11 | 0 | 1.00 | −1.00 | 0.00 |

### Example 6

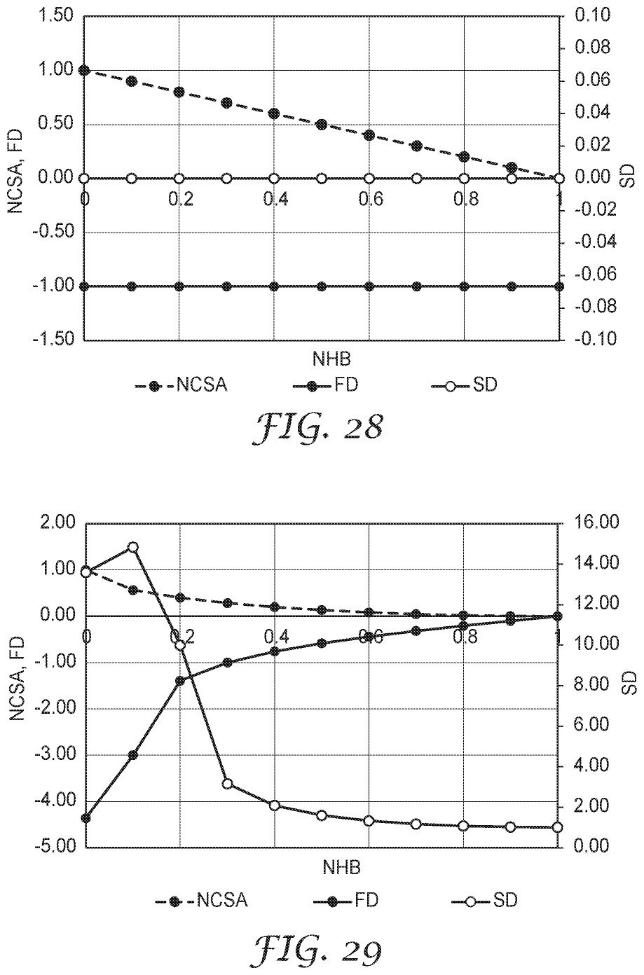

For particle geometry GS3 shown in FIGS. 20A-D, the NCSA, NSB, CSA, FD and SD were calculated in Table 6 and shown in FIG. 28. The minimum FD was −1.0 and maximum FD was −1.0, which does not meet the criterion of having a point outside the range of less than −1.5 or greater than −0.5. The maximum SD was 0.00 and the minimum SD was 0.00 which does not meet the criterion with a value greater than 0.0 and a value less than 0.0.

TABLE 6

| Plane # | NHB | NCSA | FD | SD |
|---|---|---|---|---|
| 1 | 1 | 0.00 | −1.00 | 0.00 |
| 2 | 0.9 | 0.10 | −1.00 | 0.00 |
| 3 | 0.8 | 0.20 | −1.00 | 0.00 |
| 4 | 0.7 | 0.30 | −1.00 | 0.00 |
| 5 | 0.6 | 0.40 | −1.00 | 0.00 |
| 6 | 0.5 | 0.50 | −1.00 | 0.00 |
| 7 | 0.4 | 0.60 | −1.00 | 0.00 |
| 8 | 0.3 | 0.70 | −1.00 | 0.00 |
| 9 | 0.2 | 0.80 | −1.00 | 0.00 |
| 10 | 0.1 | 0.90 | −1.00 | 0.00 |
| 11 | 0 | 1.00 | −1.00 | 0.00 |

### Example 7

For particle geometry GS4 shown in FIG. 21A-D, the NCSA, NSB, CSA, FD and SD were calculated in Table 7 and shown in FIG. 29. The minimum FD was −4.36 and maximum FD was 0.0, which meets the criterion of having a point of less than −1.5 or greater than −0.5. The maximum SD was 14.84 and the minimum SD was 1.01 which does not meet the criterion with a value greater than 0.0 and a value less than 0.0.

TABLE 7

| Plane # | NHB | NCSA | FD | SD |
|---|---|---|---|---|
| 1 | 1 | 0.00 | 0.00 | 1.01 |
| 2 | 0.9 | 0.01 | −0.10 | 1.03 |
| 3 | 0.8 | 0.02 | −0.21 | 1.08 |
| 4 | 0.7 | 0.05 | −0.32 | 1.17 |
| 5 | 0.6 | 0.08 | −0.44 | 1.33 |
| 6 | 0.5 | 0.13 | −0.58 | 1.60 |
| 7 | 0.4 | 0.20 | −0.76 | 2.09 |
| 8 | 0.3 | 0.29 | −1.00 | 3.16 |
| 9 | 0.2 | 0.40 | −1.39 | 10.00 |
| 10 | 0.1 | 0.56 | −3.00 | 14.84 |
| 11 | 0 | 1.00 | −4.36 | 13.59 |

### Example 8

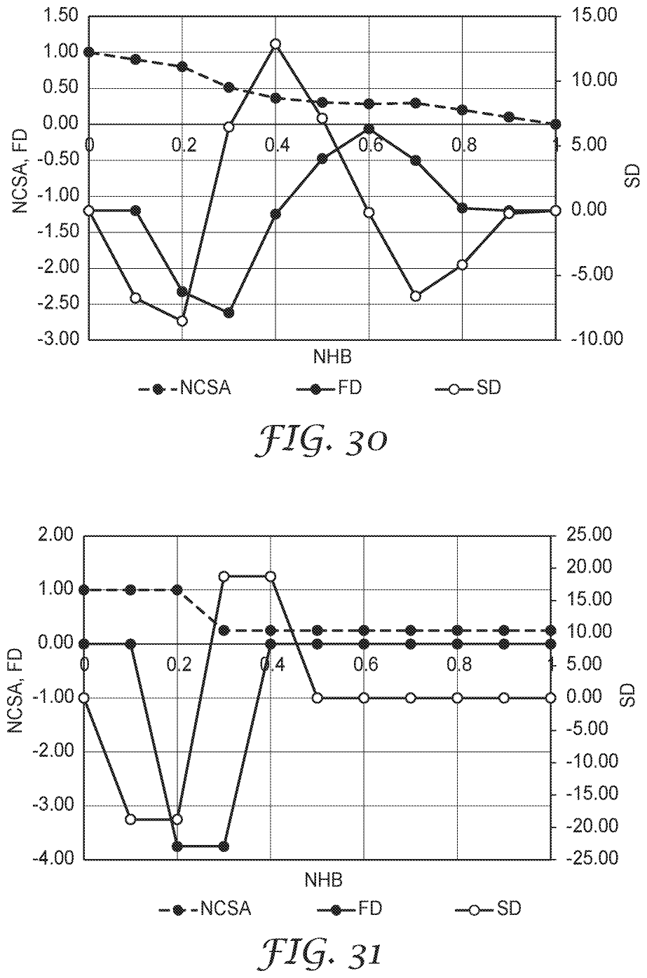

For particle geometry GS5 shown in FIGS. 22A-D, the NCSA, NSB, CSA, FD and SD were calculated in Table 8 and shown in FIG. 30. Particle geometry GS5 has a radius dimension of 0.4 mm. The minimum FD was −2.62 and maximum FD was −0.06, which meets the criterion of having a point of less than −1.5 or greater than −0.5. The maximum SD was 12.85 and the minimum SD was −8.52 which does meet the criterion with a value greater than 0.0 and a value less than 0.0.

TABLE 8

| Plane # | NHB | NCSA | FD | SD |
|---|---|---|---|---|
| 1 | 1 | 0.00 | −1.20 | 0.00 |
| 2 | 0.9 | 0.10 | −1.20 | −0.22 |
| 3 | 0.8 | 0.20 | −1.16 | −4.18 |
| 4 | 0.7 | 0.29 | −0.50 | −6.60 |
| 5 | 0.6 | 0.28 | −0.06 | −0.15 |
| 6 | 0.5 | 0.30 | −0.48 | 7.12 |
| 7 | 0.4 | 0.36 | −1.25 | 12.85 |
| 8 | 0.3 | 0.51 | −2.62 | 6.45 |
| 9 | 0.2 | 0.80 | −2.32 | −8.52 |
| 10 | 0.1 | 0.90 | −1.20 | −6.75 |
| 11 | 0 | 1.00 | −1.20 | 0.00 |

### Example 9

For particle geometry GS6 shown in FIGS. 23A-D, the NCSA, NSB, CSA, FD and SD were calculated in Table 9 and shown in FIG. 31. The minimum FD was −3.75 and maximum FD was 0.0, which meets the criterion of having a point of less than −1.5 or greater than −0.5. The maximum SD was 18.75 and the minimum SD was −18.75 which does meet the criterion with a value greater than 0.0 and a value less than 0.0.

TABLE 9

| Plane # | NHB | NCSA | FD | SD |
|---|---|---|---|---|
| 1 | 1 | 0.25 | 0.00 | 0.00 |
| 2 | 0.9 | 0.25 | 0.00 | 0.00 |
| 3 | 0.8 | 0.25 | 0.00 | 0.00 |
| 4 | 0.7 | 0.25 | 0.00 | 0.00 |
| 5 | 0.6 | 0.25 | 0.00 | 0.00 |
| 6 | 0.5 | 0.25 | 0.00 | 0.00 |
| 7 | 0.4 | 0.25 | 0.00 | 18.75 |
| 8 | 0.3 | 0.25 | −3.75 | 18.75 |
| 9 | 0.2 | 1.00 | −3.75 | −18.75 |
| 10 | 0.1 | 1.00 | 0.00 | −18.75 |
| 11 | 0 | 1.00 | 0.00 | 0.00 |

### Example 10

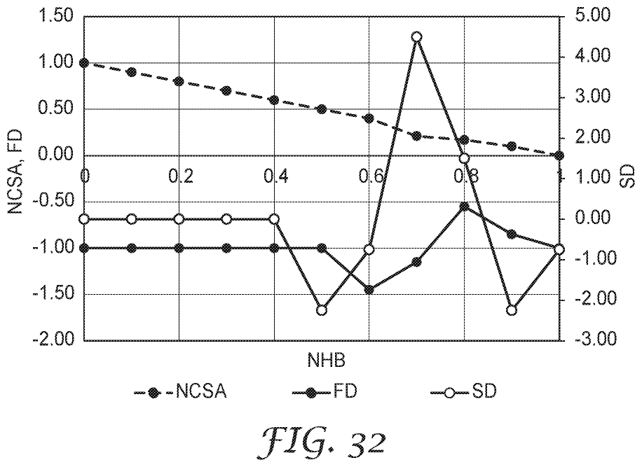

For particle geometry GS7 shown in FIGS. 24A-D, the NCSA, NSB, CSA, FD and SD were calculated in Table 10 and shown in FIG. 32. The minimum FD was −1.45 and maximum FD was −0.55, which does not meet the criterion of having a point of less than −1.5 or greater than −0.5. The maximum SD was 4.50 and the minimum SD was −2.25 which does meet the criterion with a value greater than 0.0 and a value less than 0.0.

TABLE 10

| Plane # | NHB | NCSA | FD | SD |
|---|---|---|---|---|
| 1 | 1 | 0.00 | −1.00 | −0.75 |
| 2 | 0.9 | 0.10 | −0.85 | −2.25 |
| 3 | 0.8 | 0.17 | −0.55 | 1.50 |
| 4 | 0.7 | 0.21 | −1.15 | 4.50 |
| 5 | 0.6 | 0.40 | −1.45 | −0.75 |
| 6 | 0.5 | 0.50 | −1.00 | −2.25 |
| 7 | 0.4 | 0.60 | −1.00 | 0.00 |
| 8 | 0.3 | 0.70 | −1.00 | 0.00 |
| 9 | 0.2 | 0.80 | −1.00 | 0.00 |
| 10 | 0.1 | 0.90 | −1.00 | 0.00 |
| 11 | 0 | 1.00 | −1.00 | 0.00 |

1. A shaped abrasive particle comprising:
a first and second surface, wherein the first and second surfaces are substantially parallel to each other and separated by a thickness, wherein each of the first and second surfaces have a surface profile, the surface profile comprising a plurality of corners and a plurality of edges connecting the plurality of corners;
a recess included wholly within one of the plurality of edges, wherein the recess comprises a concave void extending into the surface profile;
wherein the surface profile comprises a cutting portion and a base portion, and wherein the cutting portion has an aspect ratio between 2 and 10 and the base portion has an aspect ratio between 1.5 and 10;
a magnetically responsive coating, wherein the magnetically responsive coating causes the shaped abrasive particle to be responsive to a magnetic field; and
wherein the shaped abrasive particle, when exposed to the magnetic field, experiences a net torque that causes the shaped abrasive particle to orient with respect to the magnetic field such that each of the first and second surfaces are substantially perpendicular to a backing.

2. The shaped abrasives particle of claim 1, wherein an edge substantially perpendicular to the backing comprises a cutting face of the shaped abrasive particle, and wherein the cutting face has a first edge configured to couple to the backing and a second edge opposite the first edge, and wherein the second edge is a cutting edge configured to engage a workpiece.

3. The shaped abrasive particle off wherein an approximate first derivative of a normalized cross sectional area with respect to a normalized height has at least one value which is greater than −0.5 or smaller than −1.5, and wherein an approximate second derivative of the normalized cross section with respect to the normalized height has at least one value greater than 0 and at least one value less than 0.

4. The shaped abrasive particle of claim 1, wherein the particle has exactly 5 outside corners.

5. (canceled)

6. The shaped abrasive particle of claim 2, wherein a cross-sectional area of the particle increases non-linearly along a height of the particle, wherein the height comprises a distance from the first edge to the second edge.

7. The shaped abrasive particle of claim 6, wherein, for at least a first portion of the height of the particle, the cross-sectional area decreases, and wherein, for at least a second portion of the height of the particle, the cross-sectional area increases along the height from the first edge to the second edge.

8-10. (canceled)

11. The shaped abrasive particle of claim 1, wherein the magnetic field is at least 100 gauss.

12. The shaped abrasive particle of claim 1, wherein the magnetic field is at least 1000 gauss.

13. The shaped abrasive particle of claim 1, wherein the recess is greater than 10% of the area of the first surface.

14. A method of using an abrasive article, the method comprising:
contacting the abrasive article to a workpiece, wherein the abrasive article comprises:
a backing;
a plurality of magnetically responsive particles fixed to the backing, wherein each of the plurality of magnetic particles are fixed to the backing along a base edge such that the base edge of some of the particles are substantially parallel to each other and such that a cutting face of some of the plurality of magnetic particles are parallel to each other;
moving the abrasive article with respect to the workpiece such that a surface of the workpiece is abraded, wearing abrading the workpiece causes the plurality of magnetically responsive particles to wear down; and
wherein wearing down comprises a height of the particles to decrease with use, and wherein, for at least a portion of the height, a substantially constant cross-sectional area is maintained relatively unchanged from an initial cross-sectional area of the portion of the height during wear down.

15. The method of claim 14, wherein the substantially constant cross-sectional area has a minimum cross-sectional area and a maximum cross-sectional area, and wherein the maximum cross sectional area is less than 150% of the minimum cross-sectional area.

16. The method of claim 14, wherein the cutting face of each of the plurality of magnetic particles has a cutting edge that contacts the workpiece during abrasion.

17. The method of claim 14, wherein the plurality of magnetically responsive particles have a rake angle, and wherein the rake angle is between −29° and 170°.

18. The method of claim 14, wherein the plurality of magnetically responsive particles have exactly five corners.

19. The method of a claim 4, wherein the plurality of magnetically responsive particles have exactly six corners.

20. The method of claim 14, wherein each of the plurality of magnetically responsive particles has a cutting portion and a base portion, and wherein the cutting portion has an aspect ratio between 2 and 10, and wherein the base portion has an aspect ratio between 1.5 and 10.

21. The method of claim 14, wherein each of the plurality of magnetically responsive particles is symmetrical about a line of symmetry extending through a corner connecting a cutting edge of the cutting face and the base edge.

22. The method of claim 14, wherein the base edge of a portion of the plurality particles are substantially parallel to each other and such that a cutting face of a portion of the plurality of magnetic particles are parallel to each other, and wherein the portion is a percentage greater than would have occurred randomly.

23. The method of claim 14, wherein the base edge of a majority of the plurality particles are substantially parallel to each other and such that a cutting face of the majority of the plurality of magnetic particles are parallel to each other.
